(19) United States
(12) Patent Application Publication
(10) Pub. No.: US 2017/0102606 A1
(43) Pub. Date: Apr. 13, 2017

(54) Modular Sensing Device

(71) Applicant: Mohawk Innovations Limited, Dublin 2 (IE)

(72) Inventors: Sarah Pavis, Brooklyn, NY (US); David Michael Sutton, Brooklyn, NY (US); Aaron Saxton, New York, NY (US); Jingren Xu, Brooklyn, NY (US); Maximus Yaney, New York, NY (US); Zachary Silverstein, New York, NY (US); Mark Rosenthal, Marlboro, NJ (US)

(73) Assignee: Mohawk Innovations Limited, Dublin 2 (IE)

(21) Appl. No.: 15/386,331

(22) Filed: Dec. 21, 2016

(51) Int. Cl. G03B 17/56; H04N 5/232; H01R 13/04; H01R 13/52; H01R 13/24; G01D 11/24; H04N 5/225

(52) U.S. Cl. CPC G03B 17/563; G01D 11/245; H04N 5/23238; H04N 5/2253; H04N 5/23209; H01R 13/5219; H01R 13/24; H01R 13/04

(57) ABSTRACT

This invention relates to a device comprised of at least two interchangeable modules, wherein at least one module has a power source and/or data storage unit and can transmit power and/or data to all of the electrically and mechanically mated modules. The device is designed for use in extreme weather environments, such as but not limited to, snow, rain, at elevation, and/or under pressure. In addition, each mating point between the at least two modules is waterproof. In a preferred embodiment, the device is comprised of a first module that is an optical head, with at least two optical lenses and can sense and capture image data. A second module is a handle comprised of a battery. When the first and second modules are electrically and mechanically mated, the two modules are secure and waterproof and the device operates as a 360° optical camera with an interchangeable power handle module.

### FIELD OF THE INVENTION

This invention relates to the fields of power and data transmission and optical sensing devices. More specifically, the present invention relates to a device comprised of at least two modular components, wherein at least one module has a power source and/or data storage unit and can transmit both data and/or power to all of the modules in the device when the at least two modules are mechanically and electrically connected.

The device is designed for use in extreme weather environments, such as but not limited to: snow, rain, at elevation, and/or in a pressurized environment. In addition, each mating point between the at least two modules is waterproof.

In a preferred embodiment, the device is designed such that a first module has a sensor such as, but not limited to, an optical head that can mechanically and electrically mate to a second module that could function have the following features, including but not limited to a: base, illumination points, light emitting diodes, handle, speaker, projector, amplifier, power dock, and/or stand. The second module (non-optical head module) has a power source such as a battery, and optionally a port and/or sensor that can connect the second module to an external power source and/or external data storage unit. When the first module (optical head) and second module are mechanically and electrically connected, the first module is powered by the second module and can capture data such as but not limited to: photographs, images, environmental data, sound data, and video and transmit the data to a storage unit on the second module for transfer to another module and/or external storage device and/or data in a primary head module.

In another preferred embodiment, the second module can have a removable base cap and/or orifice for mating to a third module. When the base cap is removed from the second module, the second module will expose a second data and power transfer mechanism that can mechanically and electrically mate to the third module, wherein data and power can pass between the second and third modules.

### BACKGROUND OF THE INVENTION

There are many types of optical devices in the marketplace. However, none address the long felt need of being portable, lightweight, and allowing a user to capture photographs, images, video and/or record other data using an optical head that is both modular and detachable from the power source and/or data storage.

In a first embodiment of the present invention, the first sensor module (optical head) does not have a power source or data storage capabilities. The optical head is lightweight, small, has an improved industrial design and form factor, and allows a user to attach a variety of handles, docks, power stations, bases, and/or other modules to it.

The first module (optical head) has the ability to take and/or record data when mechanical and electrically connected to a second module (power source), such as a handle with a battery. In a preferred embodiment the first module also has a data storage unit, however in alternative embodiments the data storage unit can be in the second module. This invention teaches that the first sensor module can be an optical head having at least two lenses. When the two lenses angles of view (AOV) are combined, they provide a 360° or near 360° view of the surrounding environment. The 360° optical lenses allow for a greater angle of view, improved aesthetics, and/or video as multiple images from the multiple lenses can be stitched and/or mapped together to create a higher resolution full mosaic image.

In U.S. Pat. No. 6,734,914 (“Image Recording Unit And Camera Permitting 360° Rotation), Nishimura, et al. teach an image recording unit that can pivot to mimic the movement of a human eyeball. However, Nishimura, et al. do not teach an image recording unit with modular components, wherein the image recording unit can mate to a fully detachable module that has a power source and data storage device.

In U.S. Patent Application 2012/0105714 (“Image Capture Module Of Handheld Electronic Device With Polydirectional Rotation Function”), Li, et al. teach a handheld image capture device with a rotatable camera module. However, Li, et al. do not teach an image recording unit with modular components, wherein the image recording unit can mate to a fully detachable module that has a power source and data storage device.

In U.S. Patent Application 2001/0051509 (“Portable Terminal”), Mukai, et al. teach a portable terminal with rotatable image pickup unit. However, Mukai, et al. do not teach an image recording unit with modular components, wherein the image recording unit can mate to a fully detachable module that has a power source and data storage device.

### SUMMARY OF THE INVENTION

This invention teaches a handheld and easily portable device comprised of interchangeable modules with various types of sensors that can be mechanically and electrically mated to form waterproof and weatherproof connections. The at least one sensor can be, but is not limited to: a humidity sensor, a temperature sensor, an infrared sensor, an acoustic sensor, a sound sensor, a vibration sensor, an automotive sensor, a transport sensor, a chemical sensor, an electric current sensor, an electric potential sensor, a magnetic sensor, a radio frequency sensor, a flow sensor, a fluid velocity sensor, a radiation sensor, a navigational sensor, a position sensor, an angle sensor, a displacement sensor, a distance sensor, a speed sensor, an acceleration sensor, an optical sensor, a light sensor, an imaging sensor, a photon sensor, a pressure sensor, a force sensor, a density sensor, a level sensor, a thermal sensor, a heat sensor, a proximity sensor, a presence sensor, a sonar sensor, a micro-electrical mechanical system sensor, a radar sensor, an ultrasonic sensor, or an air pollution sensor.

The mechanical connectors to mate the at least two modules together can be, but are not limited to: a bayonet joint, slider, snap fit with or without an activator, threads, snaps, rotating and/or sliding collars, magnets, rotating but not sliding collars, and press fit snaps.

The electrical connection between the modules is comprised of multiple electrical contact points, such as but not limited to: pogo pins or retractable spring-loaded pins capable of transmitting data and power electrically and passing a ground connection. Each electrical contact point connected to a power source or data storage unit in a first module can electrically connect to an electrical target, such as, but not limited to: a pin pad and/or pin casing capable of connecting to a retractable pogo pin, on a second module.

The more electrical data contact points each module has, the faster the data can transfer between modules. In addition, increasing the size of the electrical data contact points, increases the amount of current that can transfer between modules. Increasing the size of the electrical power points, increases the amount of power that can transfer between modules.

There are various types of mechanical mating mechanisms to connect the modules, including but not limited to: bayonet joints, keys, clips, rotatable and sliding sleeves, snaps, levers that latch the modules together, hooks, and radial, horizontal, and/or vertical press-fit snaps. In addition, O-ring type seals at the connection point between the modules, prevents liquid and/or other undesirable products from entering the module and disrupting the electrical connection between the modules. These mating mechanisms are also designed to prevent the modules from decoupling, twisting and interrupting the power, data, and ground connections between the modules using key locks, sliding locks, and other mechanical fasteners.

In a preferred first embodiment of the device, a first module is an optical head and a second module is a handle. Both the optical head module and handle module are lightweight, portable, and designed to fit into a pocket of a shirt, purse, and/or backpack. In a preferred embodiment of the optical head module, the optical head has two fisheye optical lenses on opposite facets, that can capture a 360° high resolution mosaic view (when the images are stitched together).

The handle module has a power source and may also have a data storage unit. The power source can transmit power to the optical head module via electrically connected PCBs. When the optical head module is powered by the handle module, it can capture images and transmit those images (data) back to the handle for storage and/or processing to an external storage and/or processing device. In alternative embodiments, the optical head module can have a data storage unit contained within it and transfer the data to the handle during and/or after data capture.

In other preferred embodiments, the device can be comprised of an optical head (first module) that can connect to a speaker and/or audio generating unit (second module) having both a power source and data storage unit. The optical head can capture mosaic images (including video) of its environment and transmit and/or retrieve those images in real time and/or record those images alongside recording and transmitting audio from the second module. In other preferred embodiments, more than two modules with various capabilities and/or sensors can be daisy chained together and when electrically and mechanically mated, transfer data and/or power.

In another preferred embodiment of the device, a facet and/or cavity of a module that houses the spring-loaded pins may have an elastically deformable component that functions as a gasket. This gasket will create a seal between each of the pins (as opposed to around all of the pins) when two modules are mated together. This gasket prevents any water and/or liquid from closing the circuit between two pins that are at different electric potentials. In addition, this prevents any electrolysis of water and/or corrosion of the pins if two modules contact with water and/or other liquid prior to mating. In addition, any facet of a module and/or the gasket and/or sealing mechanism may have a hydrophobic and/or super hydrophobic coating to prevent electrolysis of water and/or corrosion of the pins.

### BRIEF DESCRIPTION OF THE EMBODIMENTS

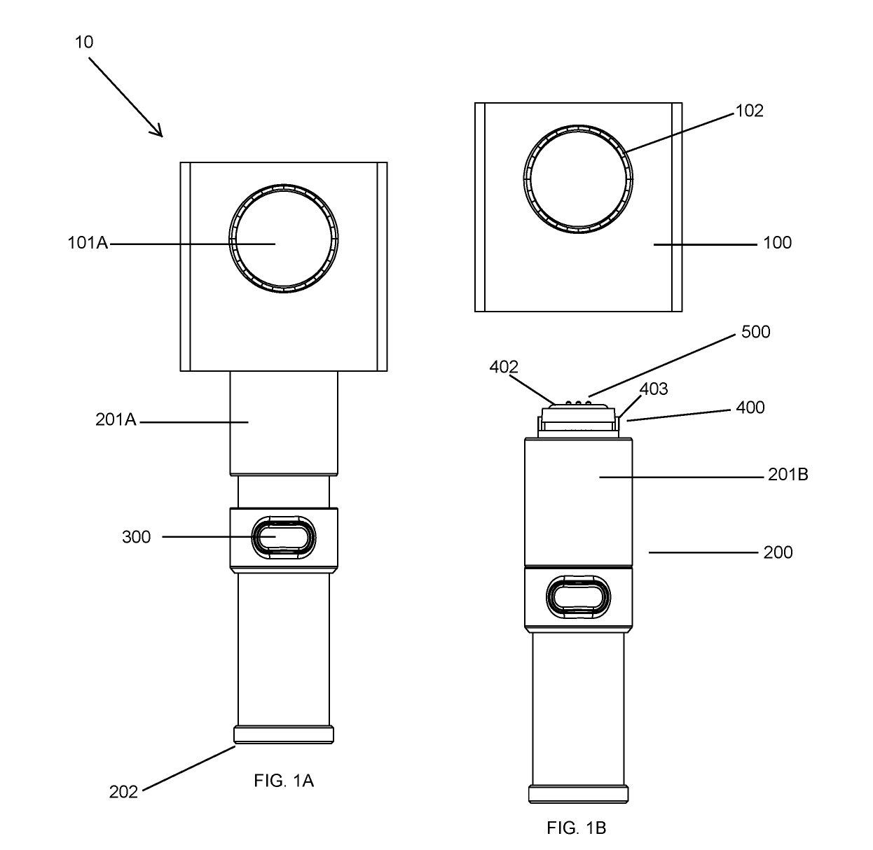

FIG. 1A shows a front view of an optical head module connected to the handle mechanism.

FIG. 1B shows a front view of the optical head module disconnected from the handle mechanism.

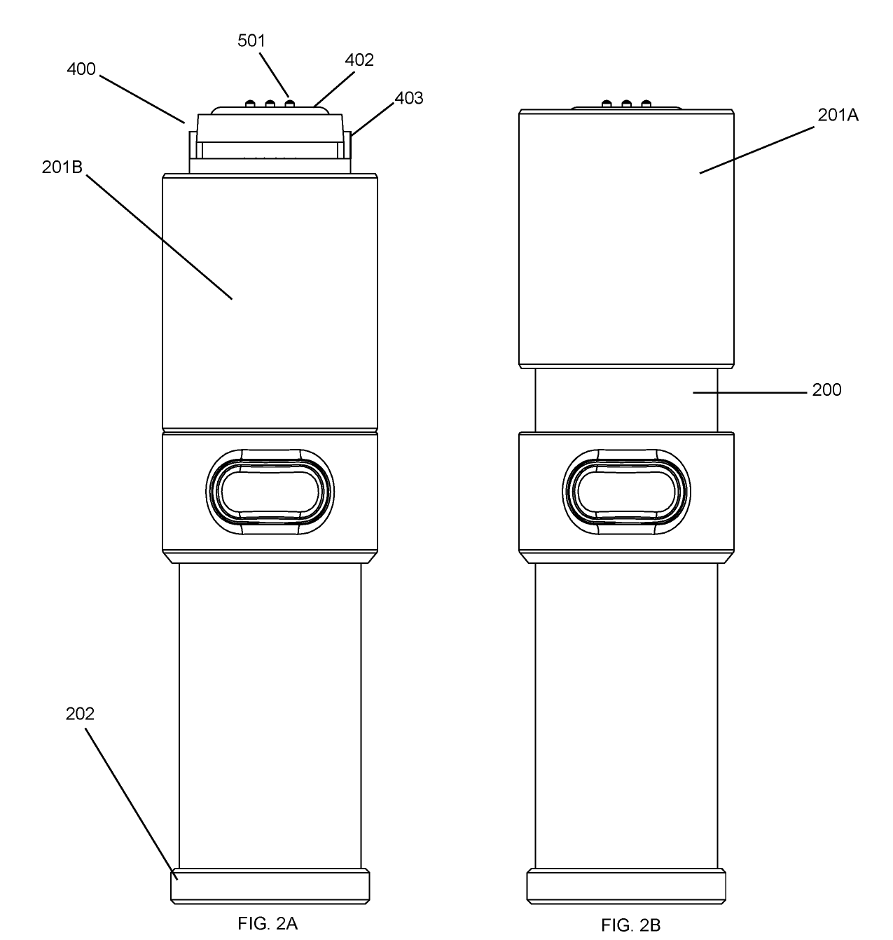

FIGS. 2A and 2B show front views of the handle mechanism with the locking sleeve down exposing the pin pad and seal, and sleeve in the upward position with only the tips of the pins exposed.

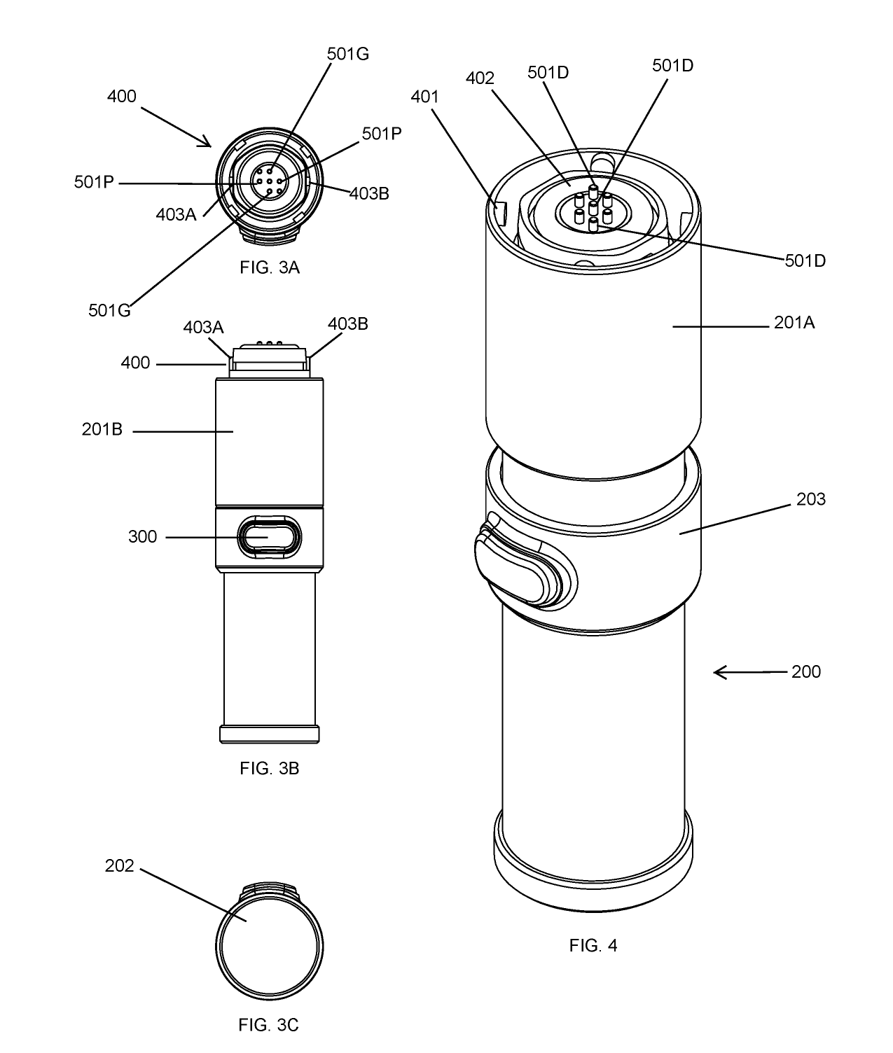

FIGS. 3A, 3B, and 3C show a top, front, and bottom view of the handle mechanism with a sleeve and bayonet mount mating system.

FIG. 4 shows a perspective view of the handle mechanism with a sleeve and bayonet mount mating system.

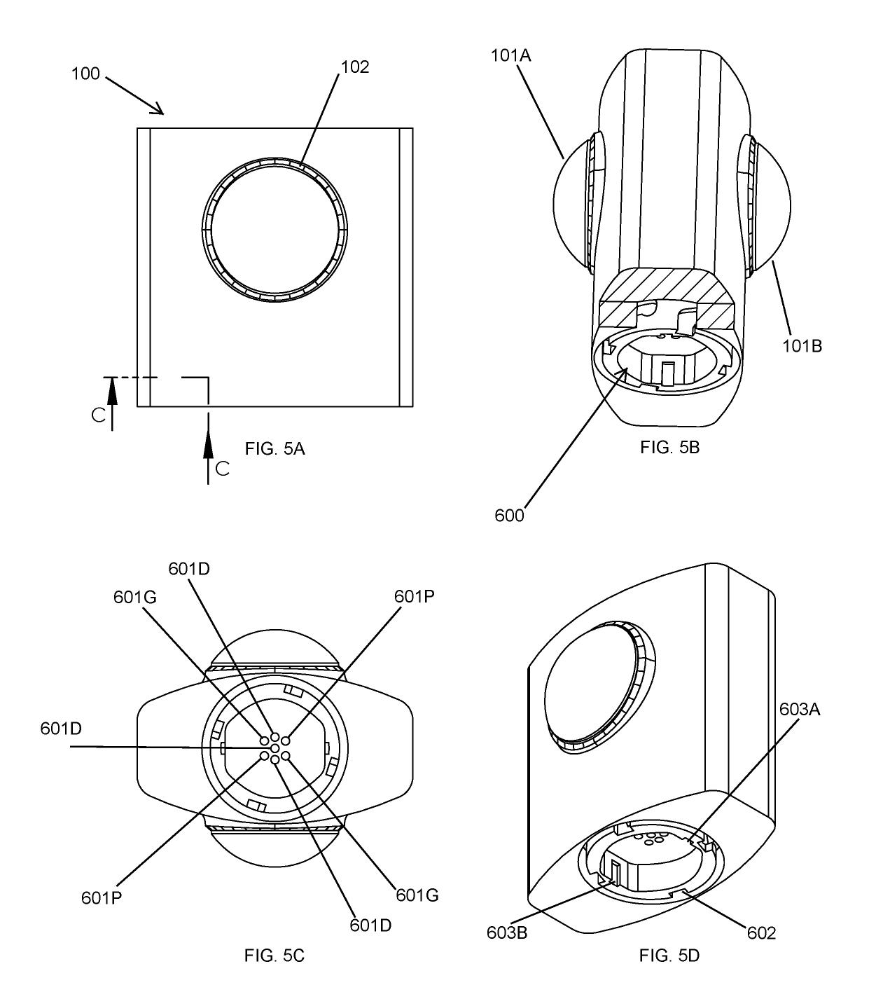

FIG. 5A shows a front view of a square optical head module with cross-section C-C.

FIG. 5B shows a side perspective view of the data, power, and ground pin insertion on the optical head module at cross-section C-C and a bayonet slot.

FIG. 5C shows a bottom view of the pin insertion and locking joint on the square optical head module with a bayonet mount mating system.

FIG. 5D shows a bottom perspective view of the square optical head module with a bayonet mount mating system.

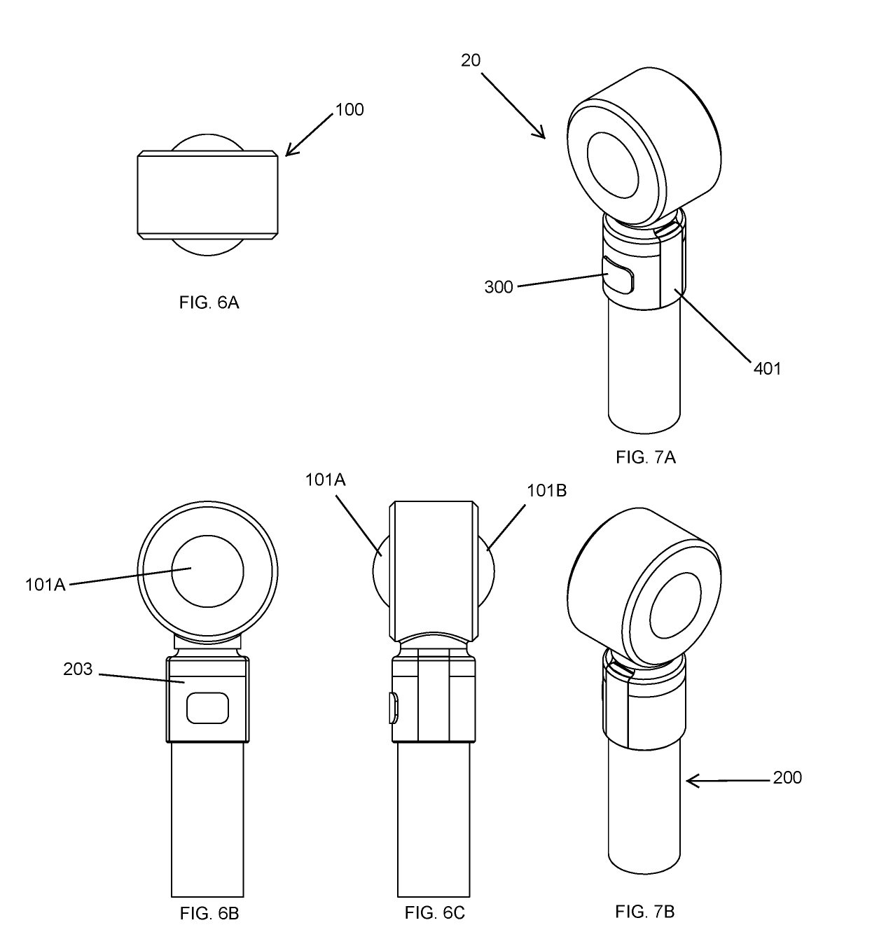

FIG. 6A shows a top view of a round optical head module and handle module for a 360° optical device with multiple lenses.

FIG. 6B shows a front view of a round optical head module and handle module for a 360° optical device having clips on either side to connect to a handle.

FIG. 6C shows a side view of a round optical head module and handle module for a 360° optical device having multiple lenses and clips on either side to connect to a handle.

FIG. 7A shows a front perspective view of a round optical head module and handle module for a 360° optical device having clips on either side to connect to a handle.

FIG. 7B shows a rear perspective view of a round optical head module and handle module for a 360° optical device having clips on either side to connect to a handle.

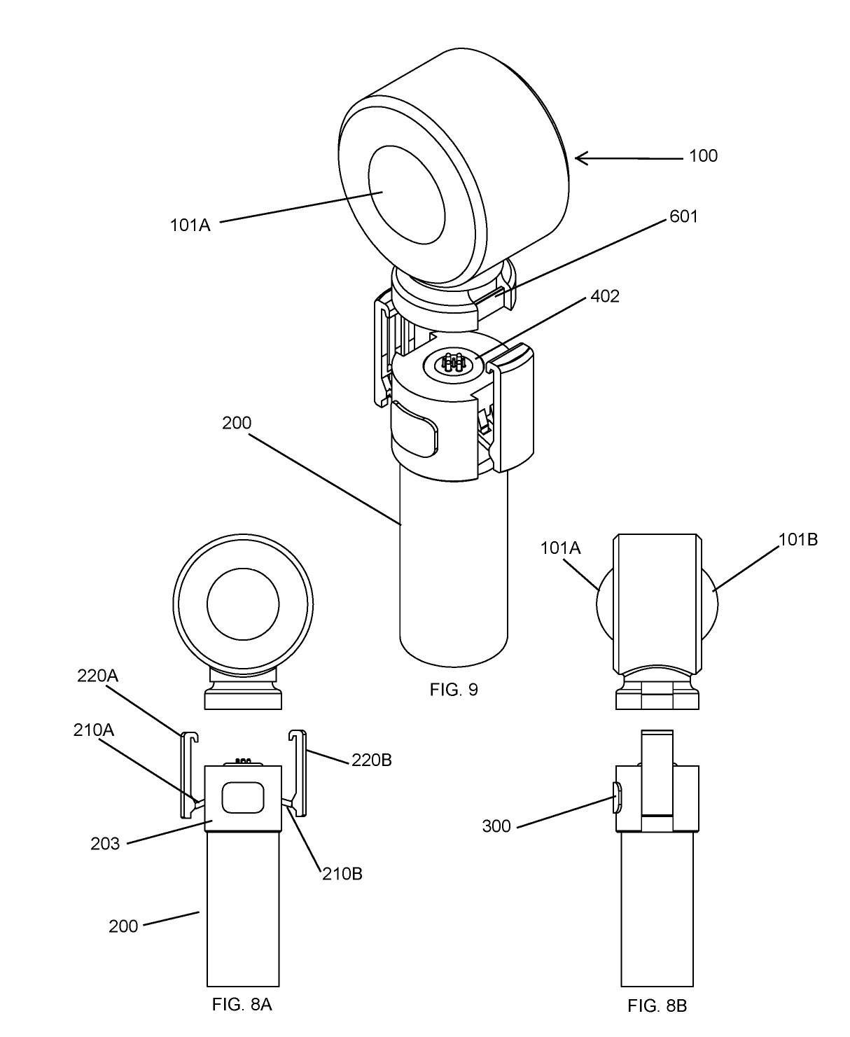

FIG. 8A shows a front view of the round optical head module detached from the handle module with side clips to mechanically connect the round optical head.

FIG. 8B shows a side view of the round optical head module with multiple lenses detached from the handle module with over-center clips.

FIG. 9 shows a side perspective view of the round optical head module detached from the handle module with over-center clips.

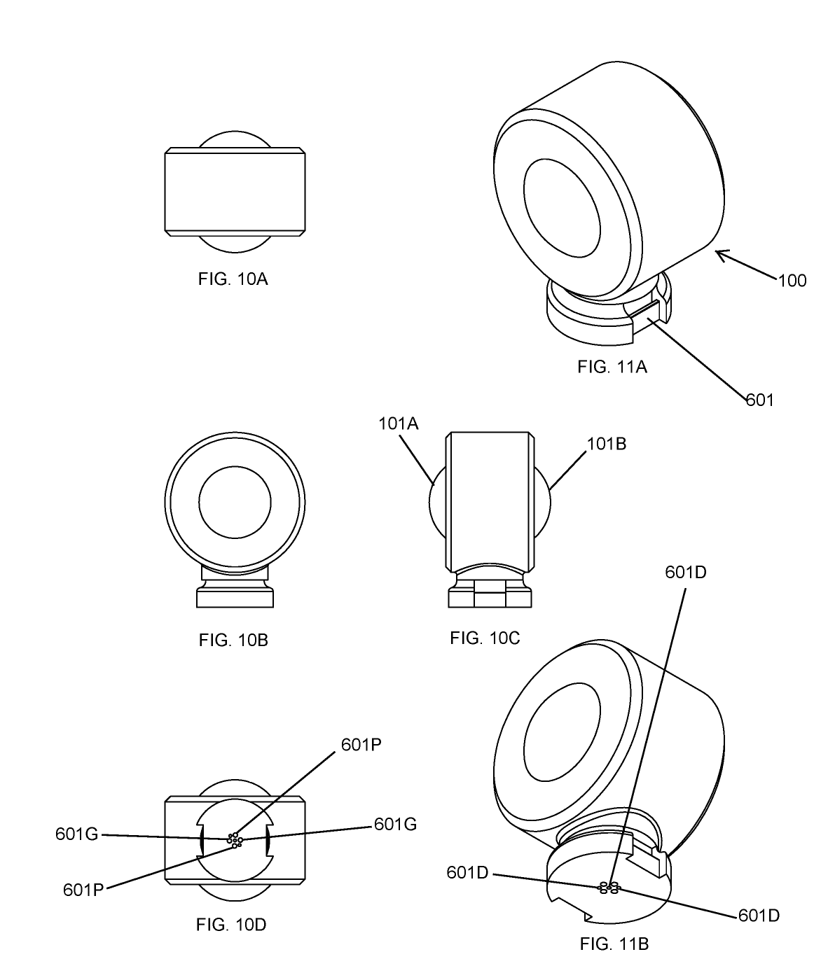

FIG. 10A shows a top view of the round optical head module for the 360° camera system with multiple lenses and side grooves for over-center clips on a secondary module to mechanically connect to.

FIG. 10B shows a front view of the round optical head module for the 360° camera system with multiple lenses and side bars for over-center clips to mechanically connect to.

FIG. 10C shows a side view of the round optical head module the 360° camera system with multiple lenses and side bars for over-center clips to mechanically connect to.

FIG. 10D shows a bottom view of the round optical head module the 360° camera system with multiple lenses and side bars for over-center clips to mechanically connect to.

FIG. 11A shows a side perspective view of the round optical head module the 360° camera system with multiple lenses and side bars for over-center clips to mechanically connect to.

FIG. 11B shows a bottom perspective view of the round optical head module the 360° camera system with multiple lenses and side bars for over-center clips to mechanically connect to.

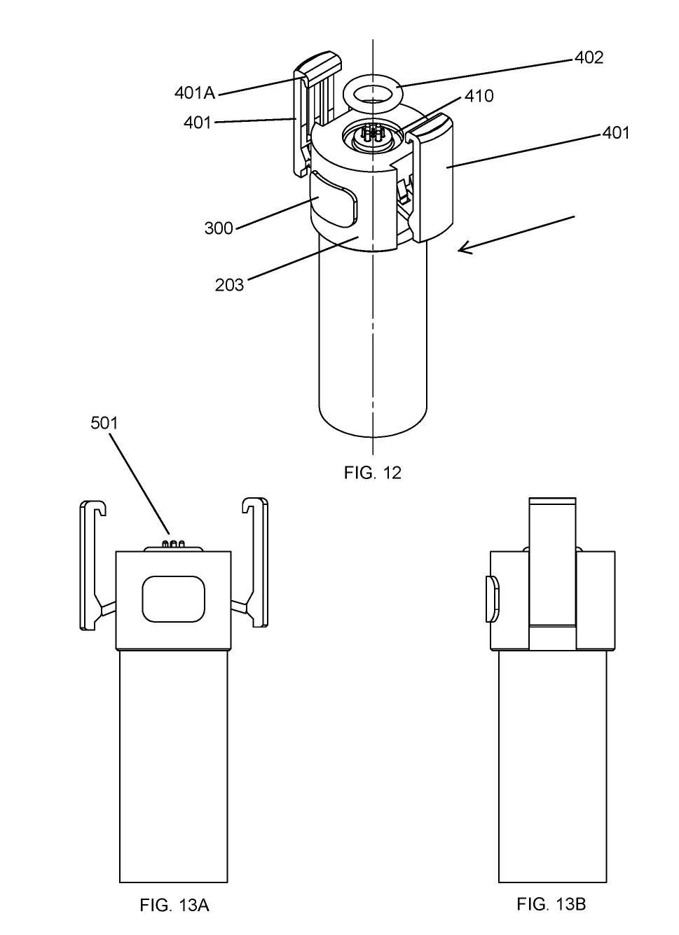

FIG. 12 shows an exploded perspective view of a handle module with over-center clips and having spring-loaded power, ground and data connection pins.

FIG. 13A shows a front view of a handle module with over-center clips that has power and data connection pins.

FIG. 13B shows a side view of a handle module with over-center clips that has power and data connection pins.

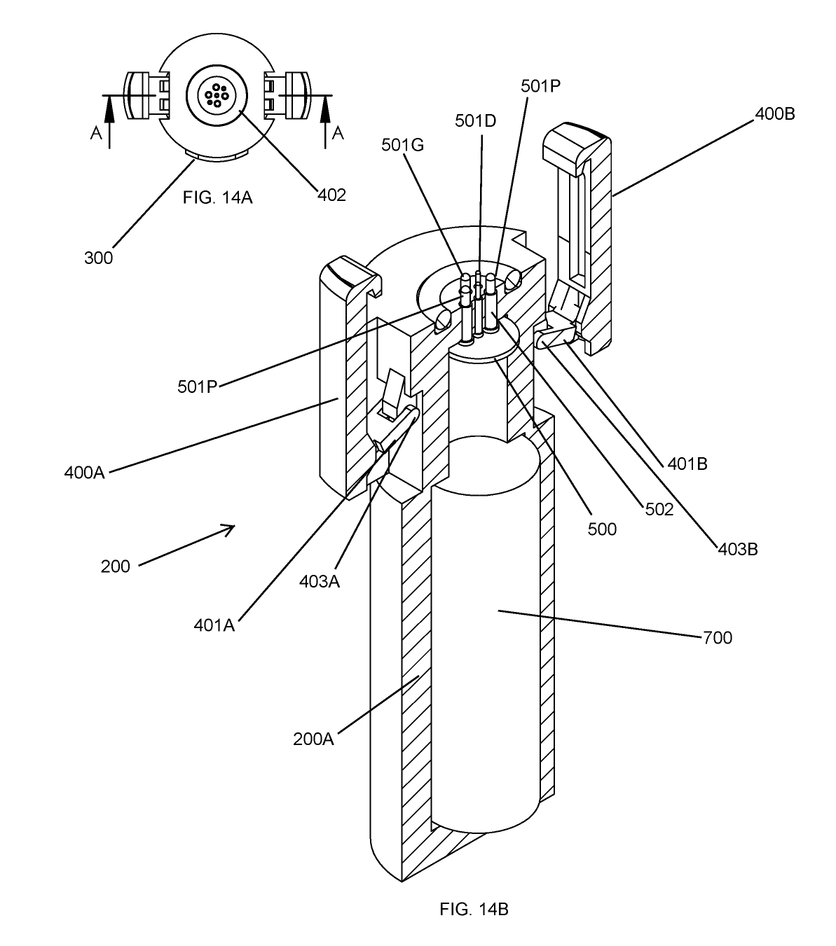

FIG. 14A shows a top view of the pins capable of transferring data and power and passing ground on a handle module with over-center clips.

FIG. 14B shows a side view at cross section A-A of FIG. 14A of the handle module with over-center clips having pins to transfer data and power and pass ground that are connected to an internal power source and data storage unit.

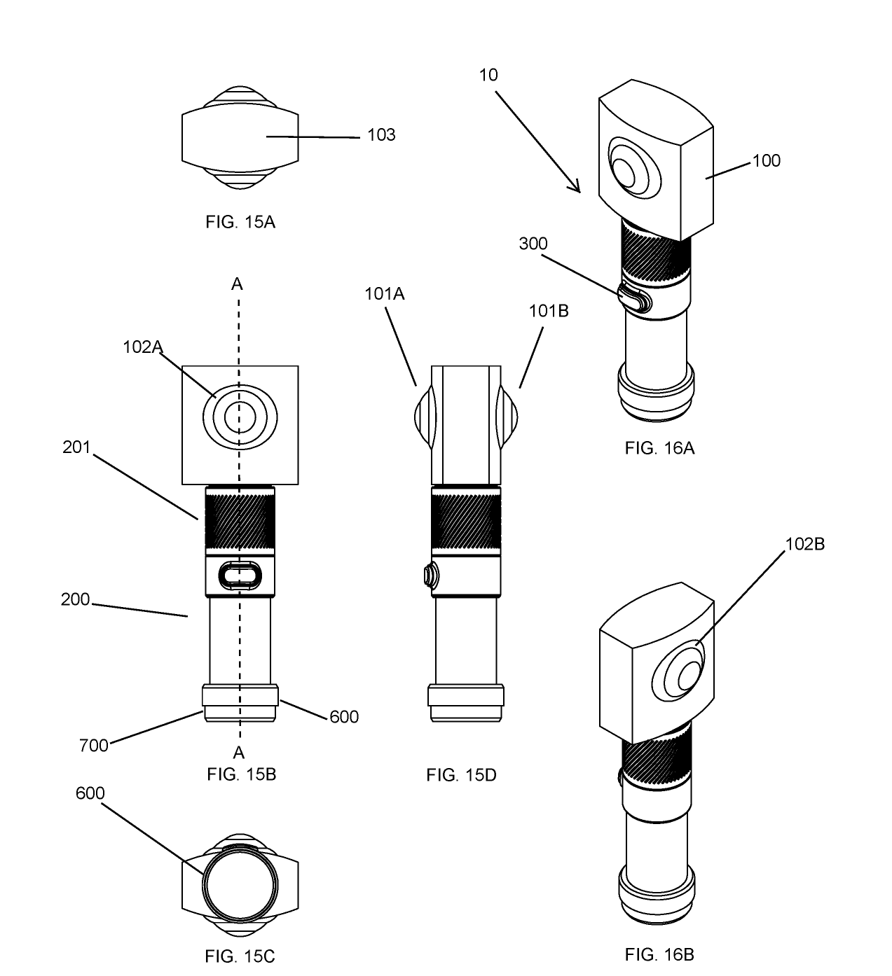

FIG. 15A shows a top view of a square optical head connected to a handle module for the 360° camera system with multiple optical lenses.

FIG. 15B shows a front view of the square optical head module connected to a handle module for the 360° camera system.

FIG. 15C shows a bottom view of a handle module for the 360° camera system.

FIG. 15D shows a side view of the square optical head module connected to a handle module for the 360° camera system with multiple optical lenses.

FIG. 16A shows a front perspective view of the square optical head module connected to a handle module for the 360° camera system.

FIG. 16B shows a rear perspective view of the square optical head module connected to a handle module for the 360° camera system.

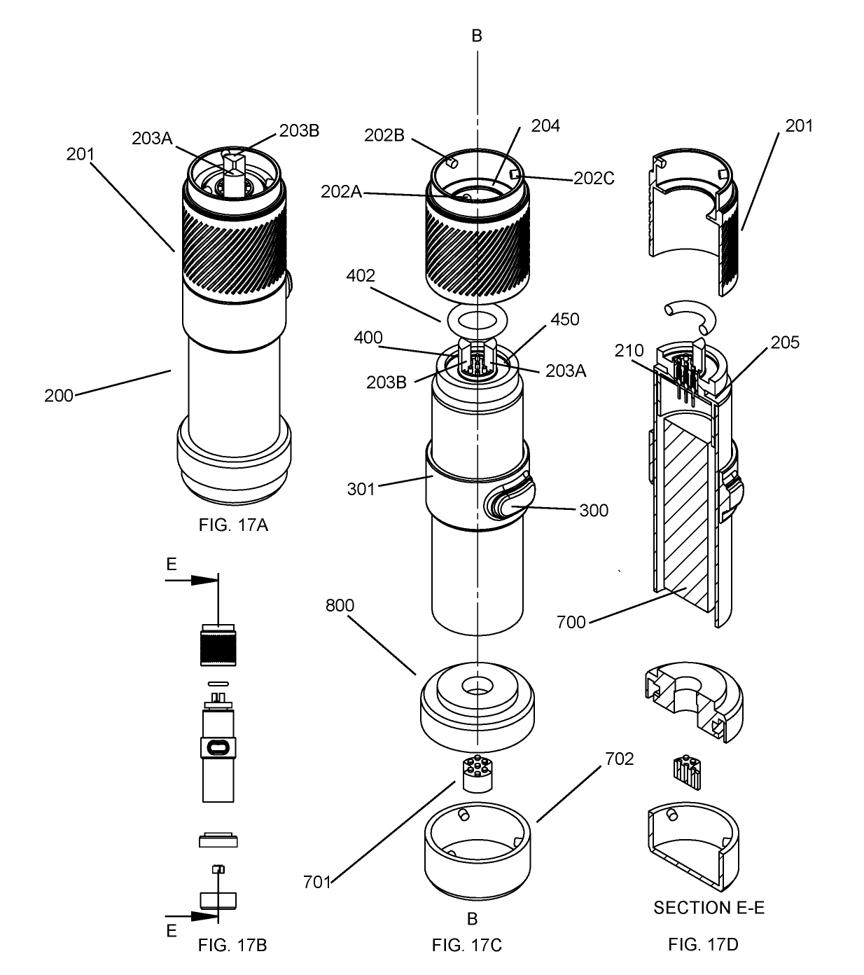

FIG. 17A shows a perspective view of the handle module for the 360° camera system with a bayonet mount connection that is bisymmetric.

FIG. 17B shows a front exploded view of the handle module for the 360° camera system wherein the handle module is exploded along axis B-B.

FIG. 17C shows a cross-section of the handle module for the 360° camera system with a bayonet mount connection that is bisymmetric wherein the handle module is exploded along plane E-E.

FIG. 17D shows a side exploded view of the handle module for the 360° camera system with a bayonet mount connection that is bisymmetric wherein the handle module is exploded along section E-E.

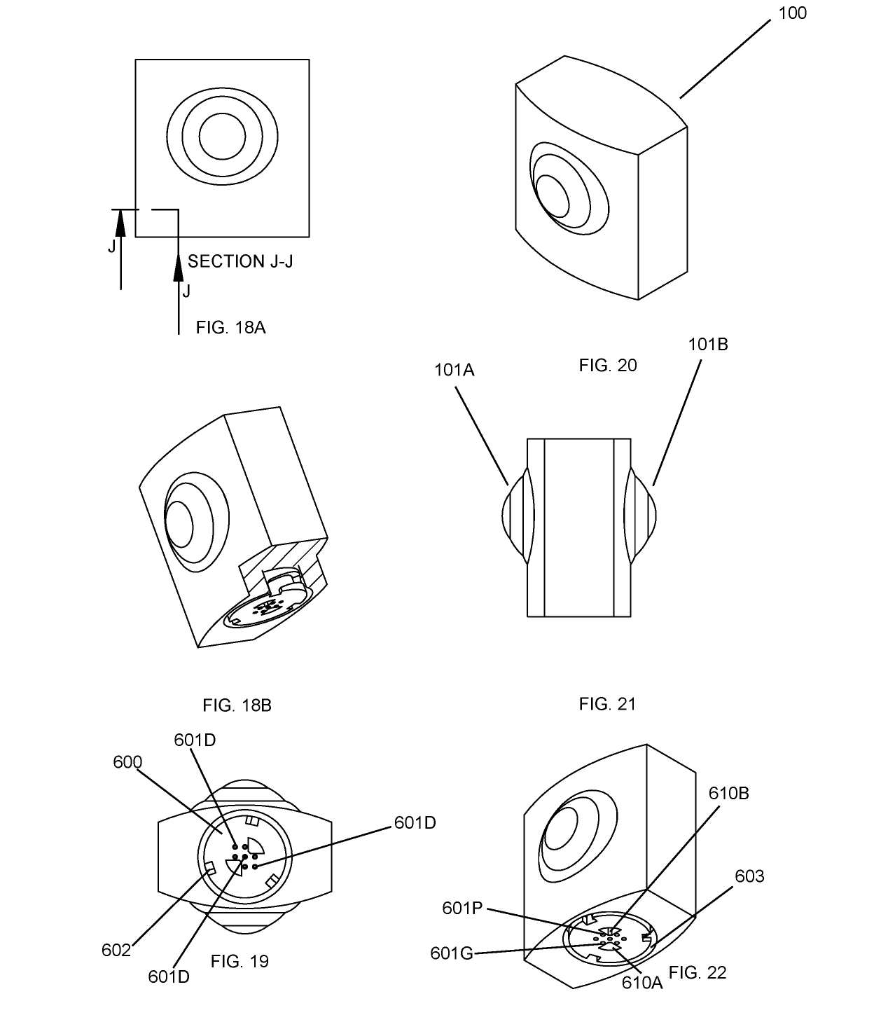

FIG. 18A shows a front view of a square shaped optical head module for the 360° camera system with section J-J.

FIG. 18B shows a bottom perspective view of the square shaped optical head module cut along section J-J as seen in FIG. 18A that is bisymmetric.

FIG. 19 shows a bottom view of a square shaped optical head module for the 360° camera system that is bisymmetric.

FIG. 20 shows a top perspective view of a square shaped optical head module for the 360° camera system.

FIG. 21 shows a side view of a square shaped optical head module for the 360° camera system with multiple optical lenses.

FIG. 22 shows a bottom perspective view of a square shaped optical head module for the 360° camera system that is bisymmetric.

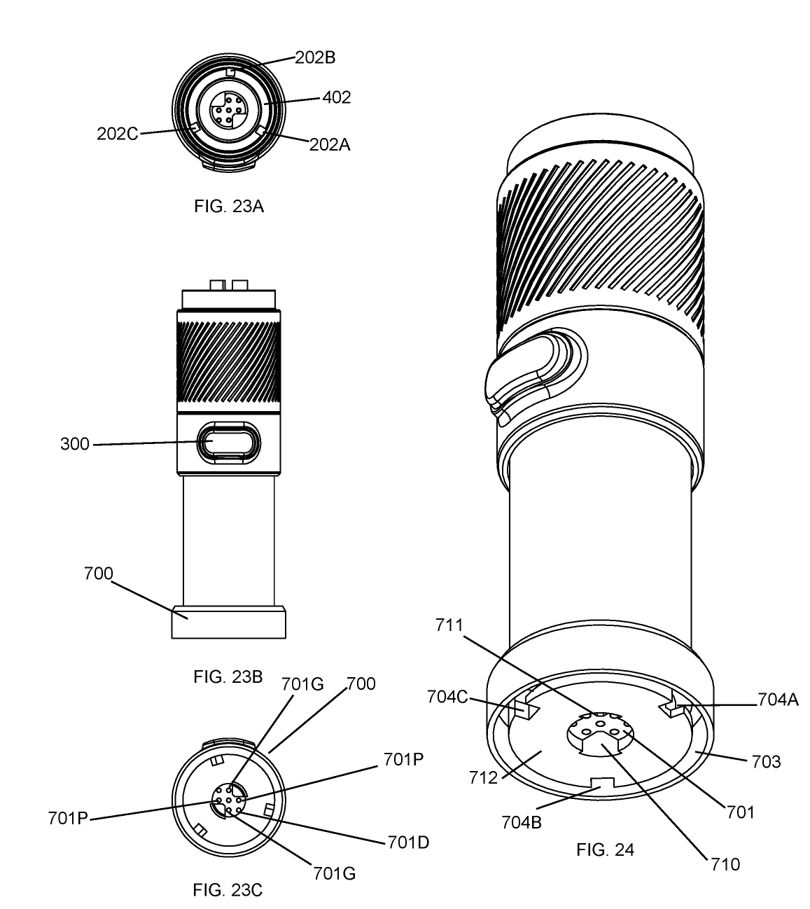

FIG. 23A shows a top view of a handle module with a male bayonet mount at the top having data, ground and power spring loaded pins, and multiple keys for locking, that is bisymmetric.

FIG. 23B shows a front view of a handle module with a male bayonet mount at the top having data, ground, and power spring loaded pins.

FIG. 23C shows a bottom view of a handle module having data, ground and power pin pads and a female orifice for a bayonet mount, multiple keys for locking, and is bisymmetric.

FIG. 24 shows a bottom perspective view of a handle module having data, ground, and power pin pads and a female orifice for a bayonet mount, and multiple keys for locking that is bisymmetric.

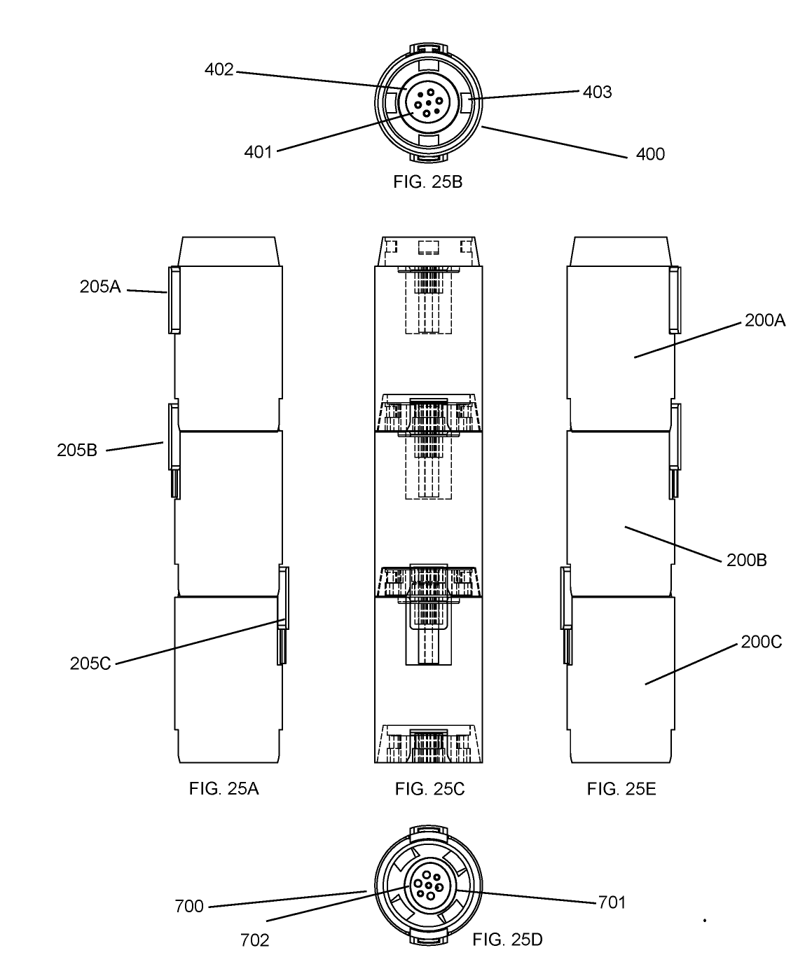

FIG. 25A shows a left side view of three modules, each with a secondary sliding lock mechanism daisy chained together.

FIG. 25B shows a top view of a module with spring loaded data and power pins, an O-ring, and a male bayonet mount that is two-way symmetric.

FIG. 25C shows a front hidden line view of three module, each with a secondary sliding lock mechanism daisy chained together.

FIG. 25D shows a bottom view of a module with data and power pin pads, an O-ring orifice, and a female bayonet mount that is two-way symmetric.

FIG. 25E shows a right side view of three modules, each with a sliding lock mechanism daisy chained together.

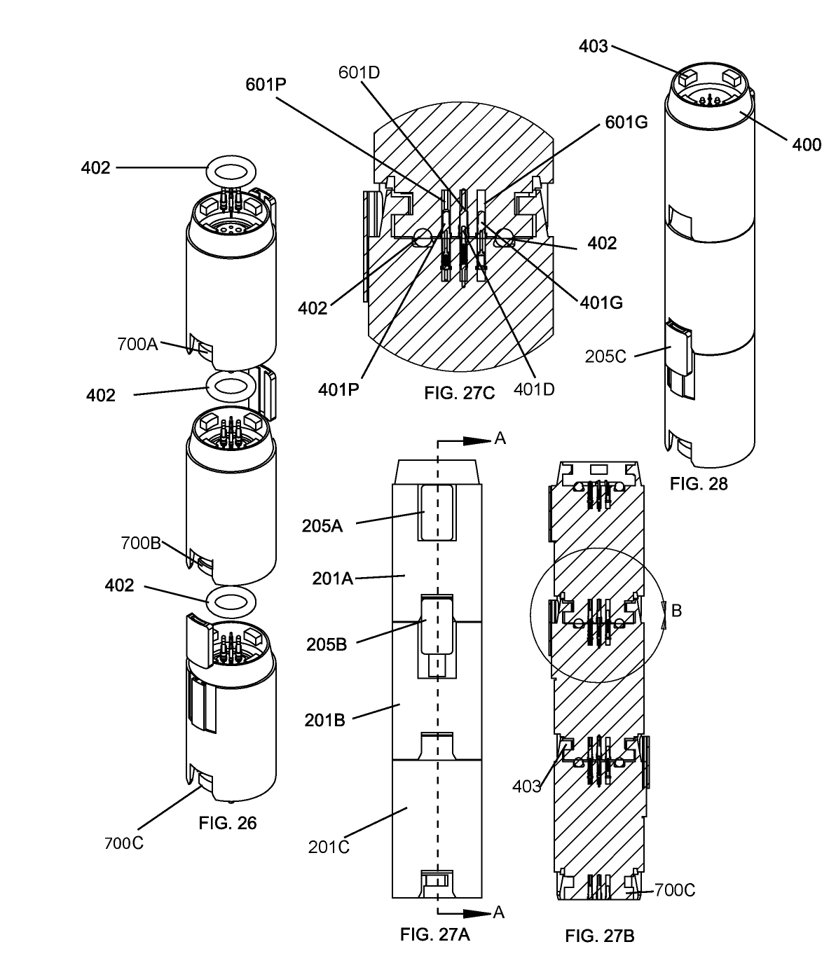

FIG. 26 shows an exploded view of three modules, each with a secondary sliding lock mechanism to keep them from disconnecting that is two-way symmetric and bayonet connector.

FIG. 27A shows a front view of three modules, each with a secondary sliding lock mechanism daisy chained together and bayonet connector.

FIG. 27B shows a cross-sectional view at section A-A of FIG. 27A of three modules, each with a secondary sliding lock mechanism daisy chained together and bayonet connector.

FIG. 27C shows a detailed view at inset B of FIG. 27B of two modules, each with a secondary sliding lock mechanism daisy chained together and bayonet connector.

FIG. 28 shows a perspective view of three modules, each with a secondary sliding lock mechanism to prevent the handles from twisting while daisy chained together and bayonet connector.

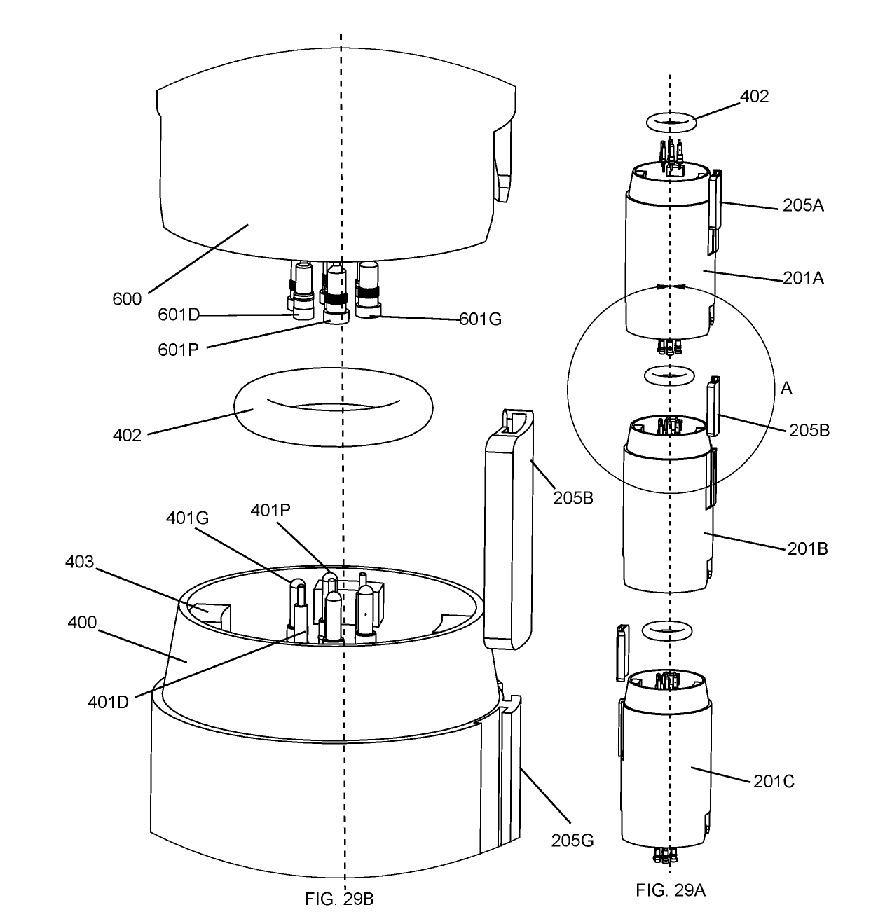

FIG. 29A shows an exploded view of three modules daisy chained together with the spring loaded pin electrical connections between each module surrounded by an O-ring that is two-way symmetric and secondary lock mechanisms.

FIG. 29B shows a detailed exploded view of the top of one module having spring loaded power, ground, and data pins connecting to the pin pads at the bottom of another module that is two-way symmetric.

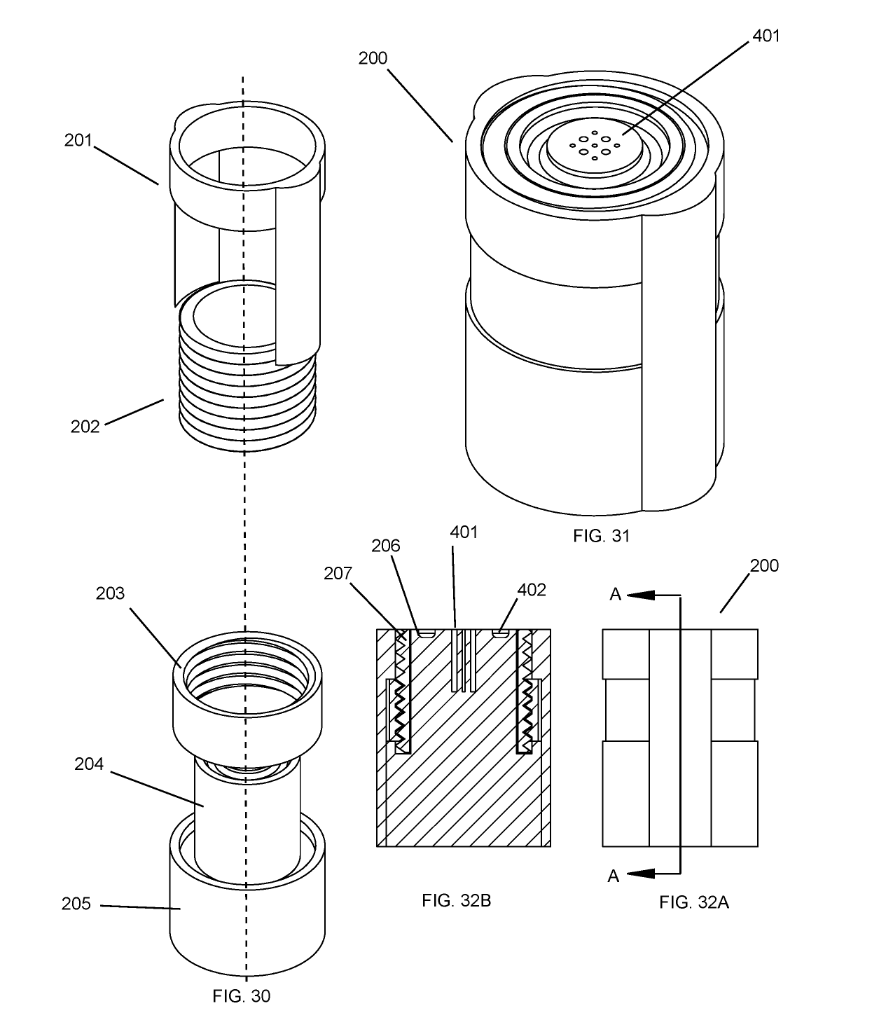

FIG. 30 shows an exploded view of an interlocking thread mechanism with an O-ring groove, wherein power and data can be transmitted, and is four-way symmetric.

FIG. 31 shows a side view of the threading locking mechanism, wherein power and data can be transmitted.

FIG. 32A shows a side view of the threading locking mechanism, wherein power and data can be transmitted.

FIG. 32B shows a cross-sectional view at A-A of FIG. 32A of the threading locking mechanism, wherein power and data can be transmitted.

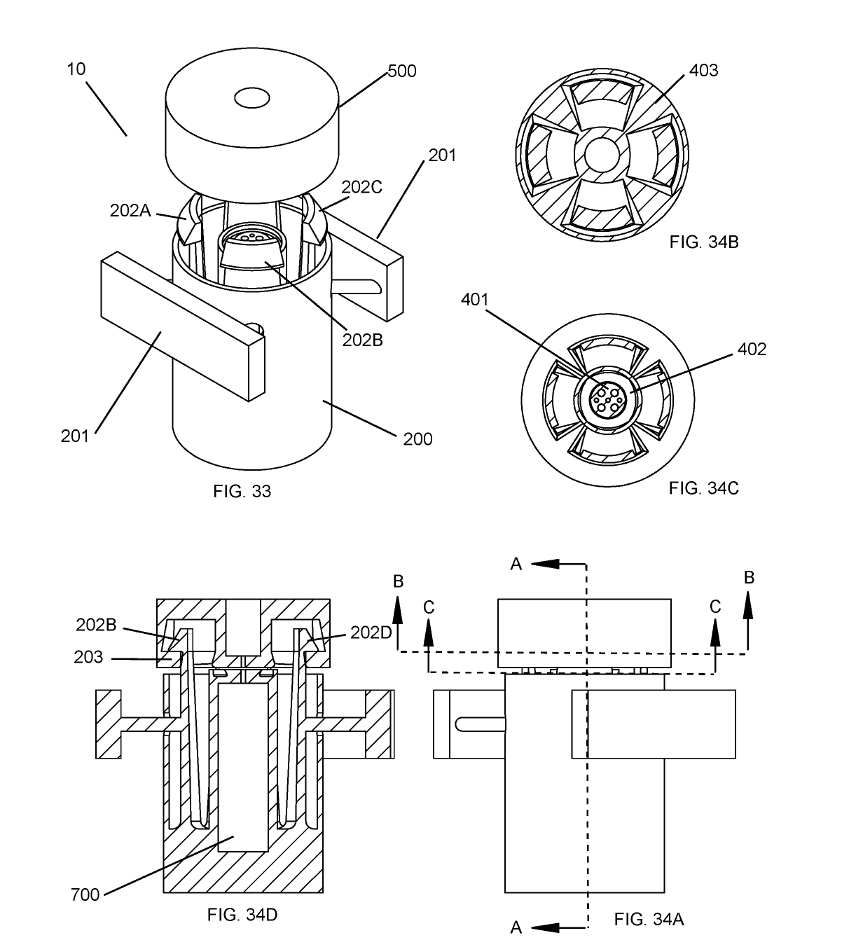

FIG. 33 shows a perspective view of two modules mating using a radial press fit locking mechanism.

FIG. 34A shows a side view of two modules mating using a radial press fit locking mechanism.

FIG. 34B shows a cross-sectional view at section B-B of the top of a first module that mates using a radial press fit locking mechanism.

FIG. 34C shows a cross-sectional view at section C-C of the data and power connection and O-ring groove between two modules that can mate using a press fit locking mechanism.

FIG. 34D shows a cross-sectional view at section A-A of two modules mating using the radial press fit locking mechanism.

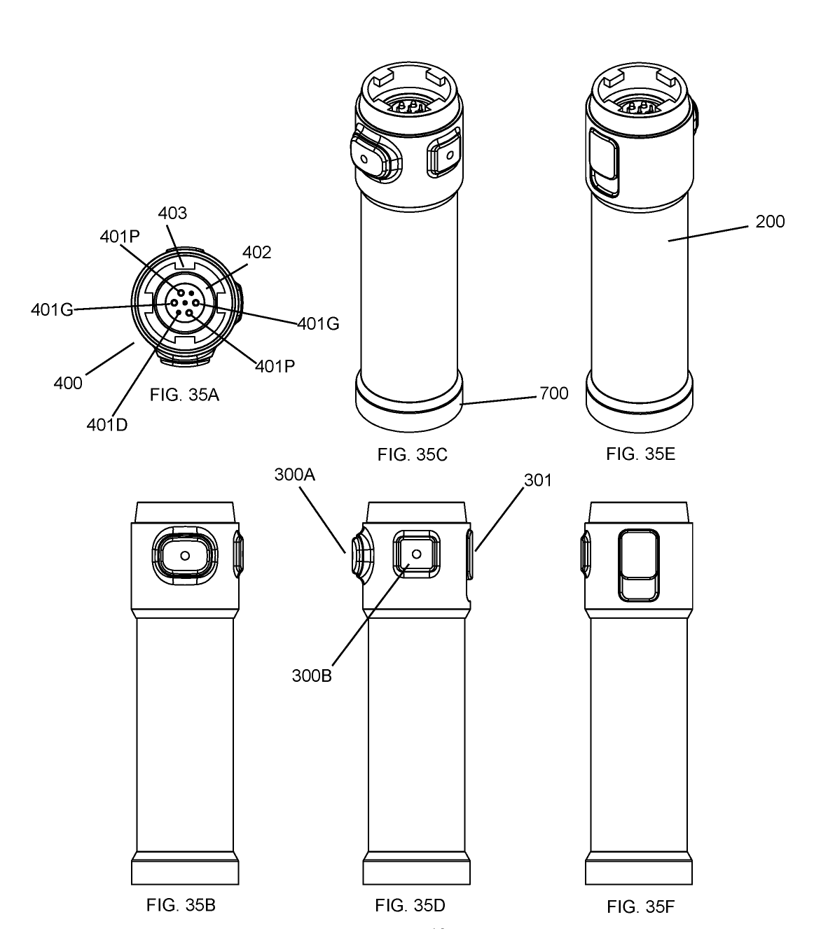

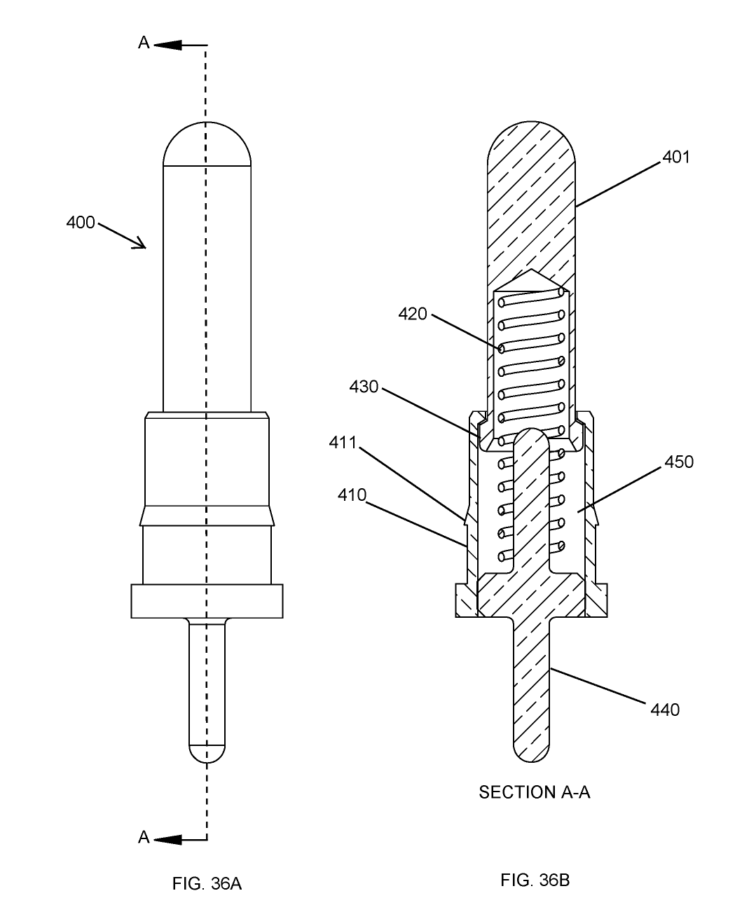

FIG. 35A shows a top view of the handle mechanism with three spring loaded data pins, two power pins, two ground pins, a sliding lock, bayonet mount, and multiple buttons that is two-way symmetric.

FIG. 35B shows a front view of the handle mechanism with multiple buttons.

FIG. 35C shows a front-right view of the handle mechanism with three data pins, and multiple buttons that is two-way symmetric.

FIG. 35D shows a right view of the handle mechanism with multiple buttons and a sliding lock.

FIG. 35E shows a rear-left view of the handle mechanism with three data pins, multiple buttons, and a sliding lock.

FIG. 35F shows a rear view of the handle mechanism with multiple buttons and a sliding lock.

FIG. 36A shows a front view of one embodiment for a retractable, spring-loaded pin with electrical conductivity.

FIG. 36B shows a cross-sectional view at A-A from FIG. 36A of a retractable, spring-loaded pin with electrical conductivity.

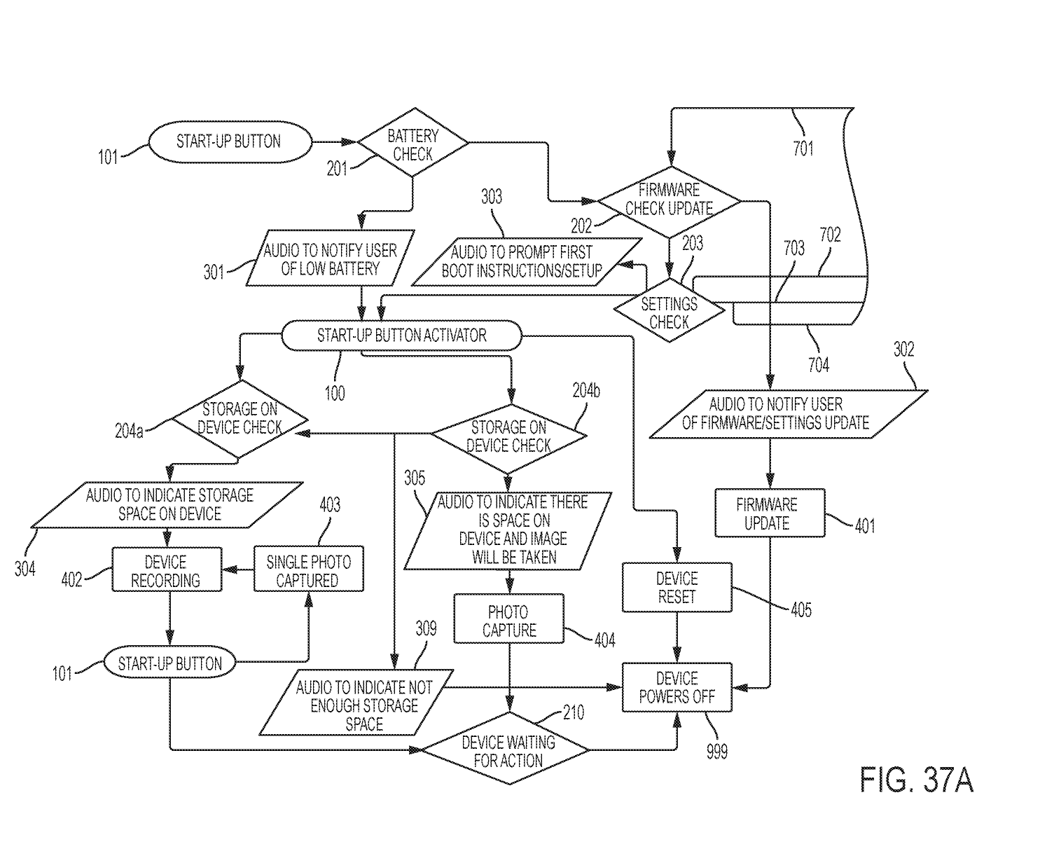

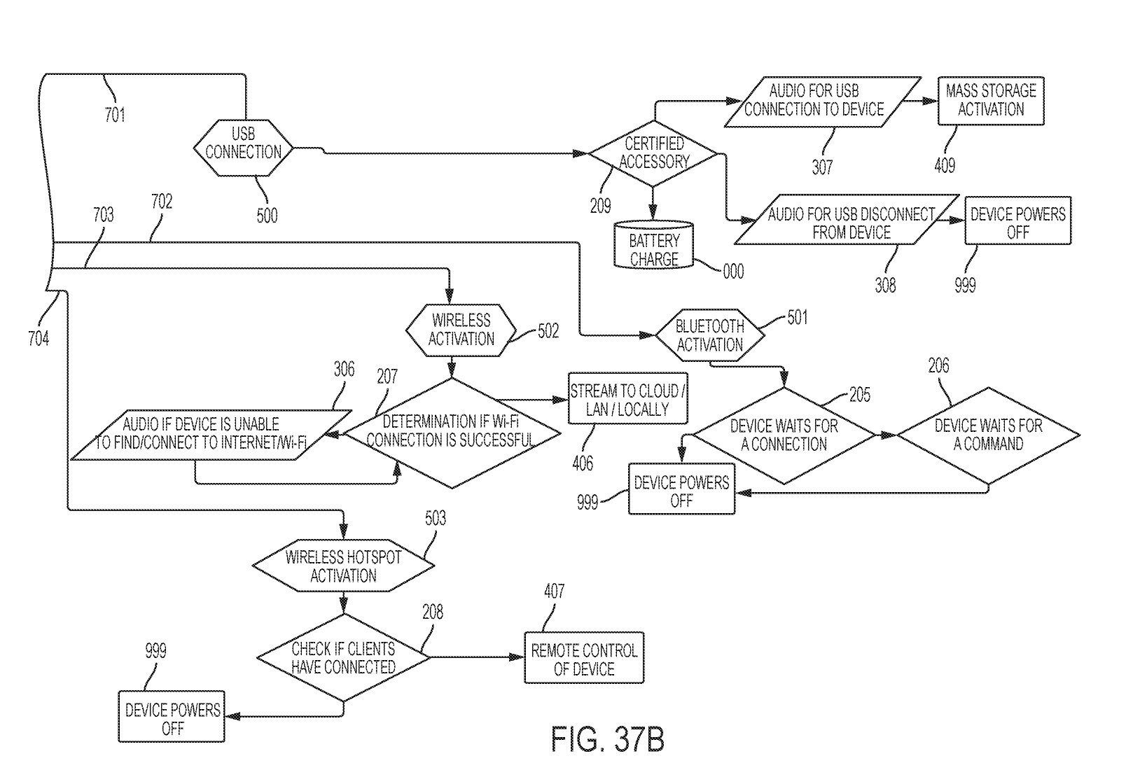

FIGS. 37A and 37B shows a flowchart of the electrical schematics of the 360° camera when the handle and optical head are electrically connected.

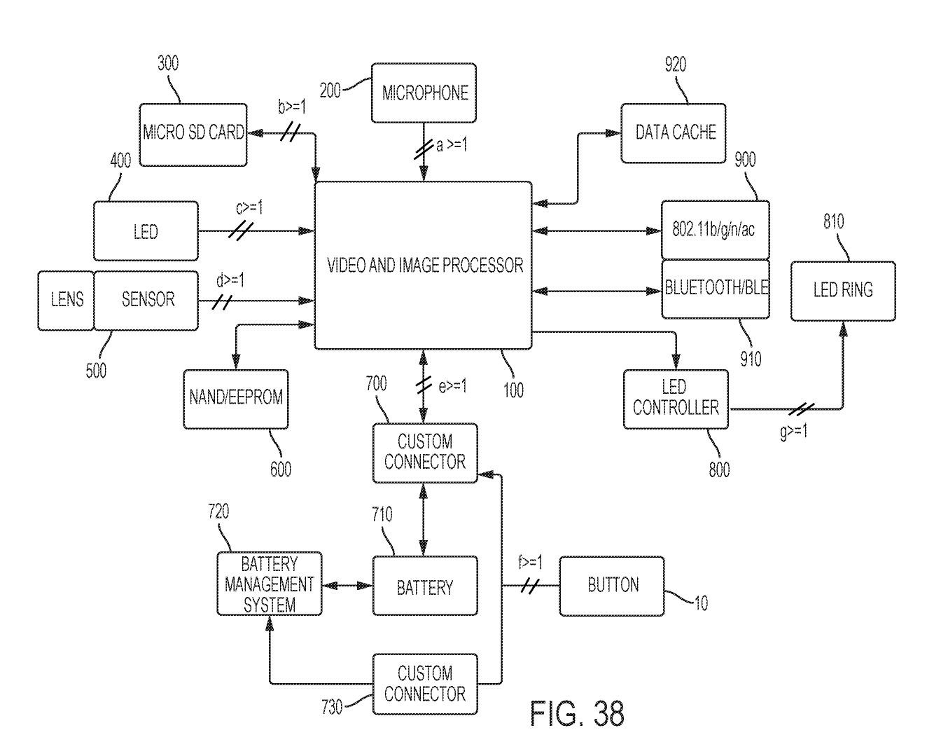

FIG. 38 shows a block diagram when an optical head sensor is electrically mated to a handle in a 360° camera.

### DETAILED DESCRIPTION OF THE INVENTION

The following is a non-limiting written description of embodiments illustrating various aspects of this invention.

This invention relates to a device having multiple interchangeable modules (components) that can transmit and/or receive both data and power from one module to the other when mechanically and electrically connected.

As used herein, the term optical device is used to mean any camera, camera head, optical head, recorder, image capture system, image record system, infrared sensing, video capture system, video record system, lens, optical lens, and/or viewing system that can capture images and/or series of images. In addition, sensing module is used to encompass any type of sensor that can capture data, including but not limited to: environmental data, weather data, audio data, frequency data, and/or image data.

As used herein, the term module is used to mean a fully detachable and interchangeable component that can be assembled into units of differing size, complexity, or function.

The term 360° is meant to encompass a system with a least two or more optical lenses and one or more imaging sensor that can capture, stream, and/or record images and/or video covering a 360° mosaic view in all spherical directions. The at least one imaging sensor can be on the sensor module (with the optical lenses) and/or on the power module. The optical lenses can be, but are not limited to panoramic lenses, fisheye lenses, and ultra wide-angle lenses. The two or more optical lenses can be stitched or mapped together where the overlap or edges of the two or more images (the at least two lenses must have at least one point of overlap for stitching to occur), videos, and/or photographs to create a single image, video, and/or photograph to create a higher resolution panoramic image.

In a preferred embodiment a first module is a sensor such as but not limited to, an optical head and the second module is a handle. The optical head can connect mechanically to the handle using a variety of mechanical attachments, including but not limited to, a bayonet lock with and/or without a sliding and/or rotatable sleeve, over the center clips, threading lock, and/or press fit lock. In alternate preferred embodiments, there can be a secondary locking mechanism to prevent inadvertent decoupling of the mechanisms.

In one embodiment of a device with multiple interchangeable modules, a first module is an optical head that connects electrically to a second module which is a handle using an electrical connector pin and target system. The handle (second module) has a first PCB with seven retractable, spring-loaded electrically conductive pins; three data pins aligned horizontally through the center of a top, exterior facet of the handle, a power and ground pin in horizontal alignment above the three data pins on the same top, exterior facet of the handle, and a ground and power pin in horizontal alignment below the three data pins on the same top, exterior facet of the handle to allow for bi-symmetric alignment. In alternative embodiments, there can be more than seven pins, including more than three data pins, and more than two ground and/or power pins.

In one embodiment of the device with multiple interchangeable power and sensing modules, the first module (optical head) has a first PCB with (preferably) seven receptacles or flat electrical contacts on a bottom facet that are electrically conductive. The three data pins, two power pins, and two ground pins on the top facet of the handle can mate to the pin pads on the bottom facet of the optical head and create an electrical connection between the handle and optical head. When an electrical connection is created and pins connect to the pin pads, both power and data can transfer between the handle and optical head. The connection is designed to be reversible, two-way, and/or four-way symmetric such that the optical head can mate in two and/or four orientations (180° and/or 90° apart) to from the second module (handle). In addition, the electrical connection between the optical head and handle has the ability to follow the universal serial bus 2.0 data and power protocol.

In alternative embodiments, the optical head may have the pins and the handle may have target pin pads, or flat electrical connectors to create an electrical connection between the optical head and handle for transfer of data and power. In additional embodiments, there can be different numbers of pins and pads for compliance and ability to follow various data and power transfer protocols, such as, but not limited to USB 3.0.

The first PCB on the optical head (first module) may also have a receptacle wherein a removable data storage unit can connect. The first PCB on the optical head (first module) may also have data storage built into it and/or be electrically connected to a second receptacle such as a daughterboard with data storage capabilities.

The first and/or second PCB on the handle (second module) may also have a receptacle wherein a removable data storage unit can connect. The first and/or PCB on the handle (first module) may also have data storage built into it and/or be electrically connected to a second receptacle such as a daughterboard with data storage capabilities.

Data stored on the on the removable data storage unit and/or internally on any module can be stored in a file format including, but not limited to: exFat, Fat32, and ext3/ext4. The data is stored in any manner so that it can be easily transferred wirelessly using protocols such as but not limited to: Bluetooth, 802.11a/b/g/n/ac on 2.4 Ghz and/or 5 Ghz to a mobile device, wearable device, and/or computer. For devices capturing sensor data using Bluetooth, the settings and other functions can be transferred and/or controlled using Bluetooth and/or Bluetooth low-energy (BLE) (BLE is only for image transfer).

In another embodiment of a device with interchangeable power and sensing modules, the mechanical connection between the first and second module may be non-symmetric wherein a first module (such as an optical head) and a second module (such as a handle) can only connect when in one orientation. In alternative embodiments, the mechanical connection can be two-way and/or four-way symmetric wherein the first and second module can connect in two orientations 180° and/or 90° apart, or any other desired symmetry for mating two or more modules.

The second module (handle) contains a power source, preferably a lithium ion and/or lithium ion polymer (LiPo) battery that may be removed from the second module. The power source is sandwiched in between two PCBs and electrically connected to each of the PCBs.

The first PCB has the data, power, and ground pins on the top facet capable of electrically mating to the pin pads on the optical head (first module). The bottom, internal facet of the first PCB electrically connects to the power source. A second PCB has a top facet that is electrically connected to the bottom facet of the power source via an electrical connector, such as a metallic spring. The second PCB has a bottom facet that has target pin pads identical to the pin pads on the bottom facet of the optical head module that can connect to a third module with retractable, spring-loaded pins such as those at the top facet of the handle. Alternatively, the second PCB can have a retractable, spring-loaded pins similar to the pins on the top, exterior facet of the handle that can connect to a third module with pin pads, such as those on the bottom facet of the optical head.

The third module can be, but is not limited to: another handle, power station, light source, docking station, and/or speaker. The third module can be daisy chained into subsequent modules using similar electrical and mechanical module mating system.

The camera head or optical head module can be of any shape or form factor including, but not limited to: circular, ovular, rectangular, or square. In a preferred embodiment, the optical head has a first camera lens on a first facet of the camera head and a second camera lens on a second facet of the camera head. In another preferred embodiment, the optical head can have three or more camera lenses on additional facets of the camera head.

A stitching algorithm is used to ensure the multiple images, photographs, video, and/or data from the multiple camera lenses are clear and capture a 360° view from the camera head.

### DETAILED DESCRIPTION OF THE EMBODIMENTS

This invention is designed such that an optical device of varying dimensions, form factors, with varying optical sensing capabilities can connect to interchangeable handles wherein both power and data storage is contained. There are varying configurations for where and how the handle and optical device mechanism can attach to create a waterproof seal for use in a variety of environments including but not limited to under water or other liquids.

FIGS. 1A and 1B show a front views of a 360° optical device 10 that is capable of capturing and storing data, images, photographs, and/or video using modules that mate using a sliding and rotating collar (bayonet lock). FIG. 1A shows the device 10 when the optical head module 100 is mated (connected) to the handle module 200. FIG. 1B shows the device 10 when the optical head module 100 is demated (disconnected) from the handle module 200. The optical head module 100 has a first optical lens 101A on a first facet of the optical head module 100. The first optical lens 101A is connected to the optical head module 100 with optical lens casing 102.

The handle module 200 contains a power source unit (not shown—such as a battery and/or AC plug) that can pass power to the optical head module 100. In addition, the handle module 200 may have an energy storage unit with a data and power management system that can pass data to the optical head module 100. The power and/or data transmission to the optical head module 100 is transmitted via pogo (spring loaded and retractable) pins 500 which are located on a printed circuit board pad that can transfer energy from the power source unit (not shown) via electrical connectors, wherein the printed circuit board and pins 500 and are surrounded by an O-ring at 402 waterproof joint 400. The pins 500 on the handle module 200 mate linearly with flat electrical connectors on the optical head module 100 (as seen in FIG. 5C, 5D).

When sleeve 201B is pushed and/or twisted in a downward motion the optical head module 100 is released from the handle module 200 and the optical head module 100 is disconnected from the pins 500 in the waterproof joint 400. When the optical head module 100 is disconnected from the handle module 200, the optical head module 100 no longer has a power source, energy storage unit and/or other mechanism to pass data. When the sleeve 201A is pushed and/or twisted in an upward motion, the optical head module 100 is connected to the handle module 200 at joint 400 and power and data from the pins 500 can pass from the handle module 200 to the optical head module 100. The joint 400 has an alignment key 403 that helps align the joint 400 and the pins 500 into the optical head module 100.

Activation of button 300 turns the device 10 on or off, captures and/or records an image, video, data, and/or photograph and/or performs other functionality such as, but not limited to recording, transmitting, saving, erasing, modifying, and/or replaying an image, video, resetting, and/or photograph taken by the optical head module 100. In addition, button 300 is capable of activating wireless communications and/or Bluetooth.

The handle module 200 has a base 202 that can be used to support the optical head module 100 and stand the device 10 upright on a table and/or other platform (not shown). In alternative embodiments (not shown) the base 202 can detach and reattach to the handle module 200.

FIGS. 2A and 2B show front views of the handle module 200 when the sleeve is in the downward position 201B and upward position 201A, respectively. When the sleeve is in the downward position 201B, a waterproof seal between the handle module 200 and the optical head module (not shown) is not created. When the sleeve is in the upward position, the handle module 200 and the optical head module (not shown) mate, create an electrical connection that can transmit power and data, and form a waterproof seal. When the sleeve is in the downward position 201B, the joint 400 that encases the data and power transmission pogo pins 501 is visible. An O-ring 402 surrounds the pins 501. An alignment key 403 helps guide the handle module 200 into the optical head module (not shown) and the pins 501 to create an electrical connection with the electrical connectors on the optical head module (not shown). When the sleeve is in the upward position 201A, only the tips of the data and power pogo pins are visible. The handle module 200 has a detachable bottom base cap 202 that can protect the pins from damage during transport and/or changing of modules.

FIGS. 3A, 3B, and 3C show the top, front, and bottoms views of a module 200 that can be used as a handle. FIG. 4 shows a side perspective view of the handle 200. FIG. 3A shows a bayonet joint 400 on the handle module 200. The bayonet joint 400 connects to the bottom of the optical head module (not shown) and creates a waterproof seal with the optical head module (not shown). The bayonet joint 400 is comprised of a pin pad and O-ring 402 to prevent liquid and/or debris from coming in contact with the pins. The pads 401 help lock the handle 200 into place when connected to the optical head (not shown). The middle pogo pins, 501D, transfer data between the handle 200 and the optical head (not shown). The exterior pogo pins 501G are pins for grounding power, while the exterior pogo pins 501P transfer power from the handle 200 to the optical head (not shown). When the sleeve is in the upward position 201A the pogo pins 501P (power), 501G (ground), 501D (data) have a waterproof connection to the optical head, and the optical head is powered and able to transmit images and/or videos. When the sleeve is in the downward position 201B, the joint 400 that connects the handle 200 to the optical head (not shown) is visible. The handle module 200 has two interior keys 403A, 403B that can insert into key orifices on a second module (as seen in key orifices 603A, 603B on FIG. 5D) to improve the seal between the handle module 200 and the optical head module (not shown).

The handle module 200, has a collar 203 that is fixed to the handle module 200. The collar 203 has a button 300 that can be activated to turn power the system, take and/or record photos, images, and/or videos, and/or transmit files. The handle module 200 has an optionally detachable base cap 202.

FIGS. 5A, 5B, 5C, and 5D show a front, side perspective, bottom and bottom perspective view of a module that is an optical head 100. The optical head module 100 has a first lens 101A, and a second lens 101B with lens casings 102 surrounding lenses 101A and 101B, respectively and helping to secure and waterproof the connection of lenses 101A and 101B to the optical head module 100. Cavity 600 at the bottom of the optical head module 100 is a space for the joint of the handle (not shown) to insert and create a waterproof seal for passing both data and power from the handle to the optical head module 100. The cavity 600 has spaces for the pads 602, as well as cavities for the pads for power 601P, data 601D, and ground 601G. The pads (or flat electrical contacts) 601P, 601D, and 601G are surrounded by an O-ring to prevent liquid or any other particles from disrupting the connection between the optical head module 100 and a handle module (not shown).

In addition, there are two key orifices 603A, 603B on the bottom facet of the optical head module 100 in the cavity 600. The key orifices 603A, 603B help the optical head module 100 align with keys on a second module such as a handle (see keys 403A, 403B as seen in FIGS. 3A, 3B). The insertion of the keys (403A, 403B in FIGS. 3A, 3B) into the key orifices 603A, 603B also helps prevent the optical head module 100 from twisting and/or decoupling from a second handle module (as seen in FIG. 3A, 3B).

FIGS. 6A, 6B, 6C, 7A, and 7B show various views of a 360° camera with a waterproof data and power transmission system 10, comprised of a round optical head 100 that can detach and reattach to handle 200 using over-center clips 401, wherein the connection between the optical head 100 and handle 200 is waterproof and allows both power and data to pass between the optical head 100 and handle 200. The optical head 100 has a first optical lens 101A on one facet and a second optical lens 101B on a second facet. Side clips 401 are connected to the sides of sleeve 203. Button 300 for power, data capture, and other functions is connected to the sleeve 203.

FIGS. 8A, 8B, and 9 show the optical head module 100 having a first optical lens 101A on a first side and a second optical lens 101B on a second side. The optical head module 100 can detachably mate to a handle module 200. The handle module 200 has an O-ring 402 that creates a waterproof seal around the electrical connection (spring loaded pins and pads) when the handle module 200 and the optical head module 100 are mated together. The over-center clips 220A, 220B on the handle module 200 have a hinge 210A, 220B and can clip around a bar 601 on either side of the optical head module 100 to further secure the connection between the optical head module 100 and the handle module 200. The over-center clips 220A, 220B are on either side of a collar 203. A button 300 to activate the optical device system and/or transmit/retrieve data is on the collar 203.

FIGS. 10A, 10B, 10C, 10D, 11A, and 11B show varying views of a module that is a round optical head 100 for the 360° camera device and can connect to a second module has two over-center clips. The optical head module 100 has a first optical lens 101A on a first facet and a second optical lens 101B on a second facet. The bottom of the optical head 100 has pads (flat electrical connection points) for data 601D, power 601P, and ground 601G pogo pins on a handle module (see FIG. 12) to connect to the optical head module 100.

In the present embodiment there are three orifices 601D for data pins to mate to. However, in alternative examples, there can be more data pads/pins as more data pins increase the rate and/or amount of data that can pass from the optical head module 100 to a module that has power and data and creates a waterproof seal with the optical head 100 (see FIG. 12). In other alternative embodiments, there could be fewer data pads to decrease the rate and amount of data that could pass from the optical head 100 to another device via a waterproof seal. The optical head module 100 has a bar 601 on each the side wherein a clip from a device that passes data and power to the optical head 100 can connect.

FIGS. 12, 13A, and 13B show various views of a module that is a handle 200 with over-center clips 401. The handle module 200 also has power and data connection pins 501. The handle has a collar 203, with a button 300 on the collar 203. The button 300 activates the power and/or data connection pins 501, resets the handle 200, and has other electronic functionalities. The collar 203 has over-center clips 401 with hooks 401A that are capable of connecting around the bar 601 has seen on the optical head 100 in FIG. 11A. When the over-center clips 401 hook around the bar 601 of the optical head 100 the optical head module 100 is securely connected to the handle module 200.

In addition, there is an O-ring 402 that surrounds the pins 501 at the top of the handle module 200. The O-ring 402 fits into an O-ring groove 410 that surrounds the pins 501. In the present embodiment, the pins 501 are spring-loaded, retractable pins capable of transferring data and power and passing a ground connection. The O-ring 402 creates a waterproof barrier around the pins 501 when the optical head module 100 (as seen in FIGS. 10A, 10B, 10C, 10D) and the handle module 200 is connected to the handle 200.

FIGS. 14A and 14B show top and side cross-sectional views of a module that is a handle 200 that can connect to an optical device module (as seen in FIG. 9) and transmit power to and transmit and receive data from the optical device module (as seen in FIG. 9). The handle module 200 has an exterior case 200A. The interior of the case 200A is a power source and/or energy storage unit 700, such as a battery. A printed circuit board (PCB) 500 is connected on one facet to the power source 700 and on the other facet connected the data pogo pins 501D, ground pogo pins 501G, and power pogo pins 501P. The data pogo pins 501D, ground pogo pins 501G, and power pogo pins 501P are each in an individual casing 502 that helps each respective pogo pin (501D, 501P, 501G) spring into and retract from its corresponding flat electrical connector on the optical head module (as seen in FIG. 11B).

The handle module 200 has a first over-center clip 400A on a first side of the handle module 200 and a second over-center clip 400B on a second side of the handle module 200 to help secure the connection between the handle module 200 and the optical head module (see FIG. 9). Each over-center clip 400A and 400B has a respective hinge 401A and 401B. Each hinge 401A and 401B rotates about two separate pivot points 403A and 403B to help each clip 400A and 400B latch around a bar on the optical head module (as shown in FIGS. 10A, 10B, 10C, 10D, 11A, and 11B) or other device that can receive and/or transmit data and/or power.

An O-ring 402 surrounds the pin pad containing pogo pins 501D, 501G, 501P. The O-ring 402 creates a seal around the pins 501D, 501G, and 501P when the clips 401 are latched around the optical head (see FIG. 9). A button 300 is connected to the handle module 200 can be activated to turn the power source and/or energy storage unit 700 on and/or off, transmit and/or receive data, and/or perform other desired functions. In alternative embodiments, multiple buttons can be used to perform additional functions.

FIGS. 15A, 15B, 15C, 15D, 16A, and 16B show various views the 360° optical camera device 10 comprised of a first module that is a square shaped optical head 100 connected to a second module that is a handle 200 using a rotating collar. The connection between the optical head module 100 and handle module 200 is waterproof and allows both data and power to pass between the handle module and the optical head module 100. The optical head module 100 has a top facet 103, first optical lens 101A and second optical lens 101B. The first optical lens 101A is surrounded by a first lens casing 102A which helps connect the first optical lens 101A to the optical head module 100. The second optical lens 101B is surrounded by a second lens casing 102B which helps connect the first optical lens 101A to the optical head module 100.

The handle module 200 has a concentric collar 201 that surrounds the handle module 200. The collar 201 can rotate about the horizontal-axis A-A. The collar 201 is fixed to the handle module 200 and the male part of a bayonet mount that connects to the optical head module 100. When the collar 201 is rotated, it locks the handle module 200 into the optical head module 100 and prevents the handle module 200 and optical head module 100 from detaching. A button 300 is used for activating the device 10, transmitting and/or receiving data, and/or other electronic communications and/or protocols.

The handle module 200 has a base 600. The base cap 700 is optionally detachable and can be removed from the handle module 200.

FIGS. 17A, 17B, 17C and 17D show various views of a handle module 200 that can transmit power and data to a secondary module. The handle module 200 has a power source and/or energy storage unit 700, such as a battery, a pin housing 400 that is comprised of a plurality of spring loaded metallic pins that are capable of transmitting and/or receiving data and power and passing a ground connection via a PCB 210, and an O-ring 402 that surrounds the pin housing 400. The pin housing 400 is surrounded by a groove 450 that the O-ring 402 can fit into.

The collar 201 is the male portion of a bayonet mount and has three locking pegs (202A, 202B, 202C) that when rotated can lock into an optical head module (as seen in FIG. 22) or other device that has a female component of a bayonet mount. In other conceivable embodiments there can be fewer locking pegs or more locking pegs and the locking pegs can be spaced uniformly or non-uniformly apart from each other. In addition there are two alignment keys 203A, 203B that can insert into alignment key orifices on another module such as the optical head module (as seen in FIG. 22) The collar 201 has a retention lip 204 that rotates about a collar retention groove 205 on the handle module 200.

The handle module 200 has a button sleeve 301 and an activator 300 for activating the device and/or performing other functions, such as but not limited to: transmitting data, capturing data, turning on/off. The bottom of the handle module 200 has an optionally removable cap 702, electrical connector 701 that can electrically connect to a PCB and the energy storage unit 700. The bottom of the handle 200 can mate to another handle-type mechanism and/or a docking system that is capable of providing power and/or data. The removable cap 702 and electrical connector 701 are mounted in a bottom housing 800 that can transmit power from a docking station module (not shown) to the power source and/or energy storage unit 700. Both power and data can pass through the electrical conductions 701 to another module (not shown).

FIGS. 18A, 18B, 19, 20, 21, and 22 show various views of a square shaped optical head module 100 that has a female component to a bayonet mount 602 that inserts into a male component of a bayonet mount as seen in FIGS. 17A, 17B, 17C, and 17D. The female bayonet mount 600 is surrounded by an annular orifice 603. The O-ring 402 (as seen in FIGS. 17B, 17C, and 17D) seals against the flat facet of the bayonet mount 600 when the optical head module 100 and handle module 200 are connected. The O-ring 402 creates a waterproof seal around the electrical connection pins and pads (601D, 601P, and 601G). In this embodiment, the male bayonet mount 600 has three pin pads for data 601D, two pin pads for ground 601G, and two pin pads for power 601P. There are three evenly spaced peg orifices 602 (females) that receive a male peg 202A, 202B, 202C from the male bayonet mount 201 as seen in FIG. 17C. In addition, there are two evenly spaced key alignment orifices 610A, 610B (females) that receive a male keys 203A, 203B from the male bayonet mount 201 as seen in FIG. 17C.

The optical head module 100 has a first optical lens 101A on a first facet of the optical head module 100 and a second optical lens 101B on a second facet of the optical head module 100.

FIGS. 23A, 23B, 23C, and 24 show various views of the handle module 200 having spring loaded pins at the top and a pin pads 701P, 701D, 701G at the bottom. The handle module 200 has a bayonet mount at the top with a plurality of pegs 202A, 202B, and 202C that can insert into peg orifices on an optical head module (as seen in FIG. 19). In this embodiment, the pegs 202A, 202B, and 202C are uniformly spaced around the O-ring 402. However in other conceived embodiments the pegs 202A, 202B, and 202C do not need to be uniformly spaced around the O-ring 402. In addition, there can be an increased or decreased number of and/or shaped pegs in other conceived embodiments.

The handle module 200 may have an optionally detachable cap on its bottom facet (in FIG. 17C the detachable cap is seen as 702). The pad housing 701 has electrical connection pads (or targets) for data 701D, power 701P, and ground 701G at the bottom of the handle module 200. The top of the pad housing 701 is electrically connected to a PCB which connects to a power source (not shown).

In this embodiment there are three electrical connection pads for data 701D. However, in other conceived embodiments there can be an increased number of data pads to increase the speed and volume of data that can be transferred. The pin pad 701 is a female connector assembly and has two alignment keyways 710, 711 that are used to mate into another module (not shown) and prevent the handle module 200 and module (not shown) mating to pin pad 701 from twisting and/or decoupling. The bottom facet 712 is an O-ring mating surface and may have a hydrophobic coating to prevent corrosion of the pads (701P, 701D, 701G).

A bottom cap 700 has an annular orifice 703 for an alignment ridge in the event that the handle module 200 is attached to another handle-type and/or docking-type module (see FIG. 26). In addition, there are three bayonet locking grooves 704A, 704B, and 704C that can receive a key (such as 202A, 202B, and 202C) from another handle-type and/or docking-type device (see FIG. 26). In this embodiment, the bayonet locking grooves 704A, 704B, and 704C are spaced uniformly around the annular orifice 703. However, in other conceived embodiments, the bayonet locking grooves 704A, 704B, and 704C do not need to be spaced uniformly around the annular orifice 703. In addition, this embodiment shows three bayonet locking grooves 704A, 704B, and 704C. However, in other conceived embodiments there can be more than three or less than bayonet locking grooves.

FIGS. 25A, 25B, 25C, 25D, and 25E show various views of three modules (200A, 200B, and 200C), each with a secondary sliding lock mechanism (205A, 205B, and 205C) daisy chained together to create a waterproof seal between each module (200A, 200B, and 200C). Each module (200A, 200B, and 200C) can transfer both data and power and ground via spring loaded data and power pins 401D, 401P, 401G at the top each module (see FIG. 25B) and data and power pad housing 701 at the bottom of each module (see FIG. 25D). In alternate embodiments, the top of a module could have pin pads and the bottom of a module could have the spring loaded data and power pins, and/or permutations thereof.

FIG. 25B refers to the top of a module (200A, 200B, or 200C). In this embodiment, there is a male bayonet mount 400. Centered in the male bayonet mount 400 is a pin housing 401 that has a plurality of spring loaded data and power pins. An O-ring 402 surrounds the male bayonet mount 400. Four uniformly spaced keys 403 surround the pin housing 401. In alternative embodiments there can be more than four keys or less than four keys. In addition, in alternative embodiments the keys do not need to be spaced uniformly apart from one another around the pin housing 401.

FIG. 25D refers to the bottom, female bayonet mount 700 of a module (200A, 200B, or 200C). The female bayonet mount 700 has a pad housing 701 in the center, that spring loaded pins (as seen in FIG. 25B) can connect with. Surrounding the pad housing 701 is an annular orifice 702 that an alignment ridge (as seen in FIG. 25B) can fit into to create a waterproof seal between two mechanisms or modules (200A, 200B, and/or 200C). In this embodiment, the cross-sectional shape of the module (200A, 200B, or 200C) is circular, however in other conceived embodiments, the cross-sectional shape can vary.

FIGS. 26, 27A, 27B, 27C, and 28 show modules (201A, 201B, 201C), each with a secondary sliding lock mechanism (205A, 205B, 205C) daisy chained together. The middle module 201B has a female bayonet mount 400 at the top, the interior wall of the female bayonet mount 400 has four pegs 403. Each peg 403 can connect to a male bayonet mount of the module 201A above it to create a secure connection between the two modules 201A and 201B. The pegs 403 surround an O-ring 402. The O-ring 402 creates a waterproof seal when the modules 201A, 201B, 201C are daisy chained together. The O-ring prevents water and/or other impediments from disrupting the power, data, and ground connections 401P, 401D, 401G, 601P, 601D, 601G.

The top of the module 201B has spring loaded pins for transmitting and/or receiving power 401P, data 401D, and ground 401G. The pins 401P, 401D, 401G connect to a pad housing 700A on the bottom of module 201A. The pad housing 700A has an electrical target pad and/or orifice for power 601P, data 601D, and ground 601G. When the power pin 401P springs into and creates an electrical connection to the power orifice 601P, power is passed from the module 201B to the module 201A. When the data pin 401D springs into and creates an electrical connection to the data pad/target 601D, data is passed between the modules 201B and 201A. When the ground pin 401G springs into and creates an electrical connection to the ground orifice 601G, a ground connection is passed between the modules 201B and 201A. The O-ring 402 prevents liquid and/or other sediment from interrupting the power, ground, and/or data connections between the modules 201A, 201B, and/or 201C.

There is a secondary sliding lock 205B that when pushed upward, prevents the modules 201A and 201B from rotating about the central vertical axis and disconnecting the electrical power and data connections between the two modules 201A and 201B.

The bottom module 201C has a female bayonet mount 400 at the top, the interior wall of the female bayonet mount 400 has four pegs 403. Each peg 403 can connect to a male bayonet mount of the module 201B above it to create a secure connection between the two modules 201B and 201C. There is a secondary sliding lock 205C that when pushed upward, prevents the modules 201B and 201C from rotating about the central vertical axis and disconnecting the electrical power and data connections between the two modules 201B and 201C.

In FIGS. 26, 27A, 27B, and 28 three modules 201A, 201B, 201C are depicted as daisy-chained together to pass both power and data. However, in alternative embodiments, there can be more than three modules or fewer than three modules. In addition, in other conceived embodiments, the bottom module can consist of a docking station, power base, longer handle and/or other mechanism connected together. Further, in other conceived embodiments, a module in any position in the chain can consist of a module with a data sensing module, such as an optical head capable of recording data, images, photographs, and/or other metrics, environmental sensor, and/or audio sensor.

FIGS. 29A and 29B show various exploded views of the connection between modules 201A, 201B, and 201C. The top of the module 201A, 201B, or 201C has a housing 400. Contained in housing 400 are three spring loaded data pins 401D, two spring loaded power pins 401P, and two spring loaded ground pins 401G in the center of the female piece of a bayonet mount. There are four uniformly spaced keys 403 surrounding the spring loaded pins 401D, 401P, and 401G. An O-ring 402 surrounds the spring loaded pins 401D, 401P, 401G and creates a waterproof seal between the pins 401D, 401P, 401G and the flesh/flat electrical connector target pads 601D, 601P, 601G at the bottom of module 201A, 201B, or 201C. The pin pad portion of the male bayonet mount 600 has multiple orifices for data 601D, power 601P, and ground 601G. When the data pins 401D springs into and creates an electrical connection to the data pad 601D, data can pass between the two modules. When the power pins 401P springs into and creates an electrical connection to the power pad 601P, power can pass between the two modules. When the ground pins 401G springs into and creates an electrical connection to the ground pad 601G, a ground connection between the two modules is created.

In this embodiment, each module 201A, 201B, and 201C has a track 205G. A secondary sliding lock mechanism 205A, 205B, 205C, respectfully, can slide upwards and downwards on the track 205G. When the secondary sliding lock mechanism 205A, 205B, 205C is in the upward position, it creates a lock between the module 201A, 201B, 201C and the module above it. The secondary sliding lock mechanism 205A, 205B, 205C prevents the modules 201A, 201B, 201C from twisting and the electrical connections between the pins 401D, 401P, 401G and pads 601D, 601P, 601G, respectfully, from disconnecting.

In alternative embodiments, the track 205G can be a post or a plurality of posts, and/or any other mechanism that constrains the motions of the secondary sliding lock mechanism 205A, 205B, 205C to a linear movement.

FIGS. 30, 31, 32A, and 32B show various views of a threaded locking mechanism 200 that can be used to create a waterproof connection between two modules, wherein the power and data can be transmitted and/or received between the two modules. A threaded locking mechanism 200 has a base 205, interior thread 204 having an insulated housing 401 with spring loaded data, power and ground pins, a collar 203, second interior thread 202, and sleeve 201. An annular groove 206 surrounds the housing 401 to create a groove for an O-ring 402 which creates a waterproof seal between the threaded locking mechanism 200 and the device that the threaded locking mechanism 200 can connect with. The collar 203 is connected to and rotatable around threads 207 on the perimeter of the second interior thread 202.

In this embodiment, the threaded locking mechanism 200 is four-way symmetric. However, in alternative embodiments, the connection can be two way symmetric or have other symmetries.

FIGS. 33, 34A, 34B, 34C, and 34D show various views of two modules, (first module) 200 and (second module) 500 mating electrically and mechanically with a radial press fit locking mechanism 10. The first module 200 has an interior cavity containing a power source and/or energy storage unit 700, such as a battery. The first module 200 has activators 201 on either side of it that can be pressed or otherwise activated to inset snap 202A, 202B, 202C, and 202D. When snaps 202A, 202B, 202C, and 202D are depressed they unhook from the lip 203 and the second module 500 can detach from the first module 200. The second module 500 has a pin pad (not shown) connected to a PCB (not shown) that has a sensor for sensing data. The second module's 500 pin pad (not shown) connects electrically to the first module's 200 pin housing 401 and the pins on pin housing 401 can transmit data, ground, and power from the first module 200 to the second module 500.

First module 200 has a central pin housing 401. The pin housing 401 has three spring loaded data pins, two spring loaded power pins, and two spring loaded ground pins that can connect electrical to the bottom of second module 500. The connection between the first module 200 and the second module 500 is two-way symmetric, but in alternative embodiments can have more data connection pins and pads to increase the speed and volume of the data transfer and/or type of symmetry between the modules. An O-ring 402 surrounds the pin housing 401 preventing liquid and/or other sediments from interrupting the connection between the pins on the first module 200 and the pads on the second module 500.

In alternative embodiments, the press fit locking mechanism can be vertical, horizontal, have other geometries, and/or orientations.

FIGS. 35A, 35B, 35C, 35D, 35E, and 35F show various views of a handle module 200 with multiple buttons 300A, 300B, a slider for locking 301, a pin pad 401 having multiple spring loaded data pins 401D, power pins 401P, and ground pins 401G that are capable of connecting to another device (not shown) and transmit and receive power and/or data, an O-ring 402 sealing the connection between the handle module 200 and the other device (not shown), and multiple pegs 403 that prevent the handle module 200 from twisting, dealigning and/or disconnecting the pins 401D, 401P, 401G from its target pads (not shown).

In the present embodiment, the handle module 200 has two buttons 300A, 300B, and a slider for locking 301. However, in other conceived embodiments, the handle module 200 can have more than two or fewer than two buttons. In addition, each button can have different and/or multiple functionalities, including but not limited to, power on and/or off, reset, restart, timing, transmitting, receiving, recording, photo and/or image capture, data capture, audio capture, language and/or time setting, and/or charging. The button and/or buttons can be of any form factor and/or use any type of activation mechanism, including but not limited to, pushing, twisting, depressing, snapping, locking, and/or sliding. In addition, there can be other sensors and/or activators such as, but not limited to, wireless charging, motion sensing, temperature sensing, and/or audio sensing. The sliding lock 301 connects the handle module 200 to a secondary module (not shown) and prevents the two modules from twisting and/or decoupling.

FIGS. 36A and 36B show a front view and cross-sectional view of a retractable, spring-loaded pin 400 that is electrically conductive and can transfer power, data, and/or ground from a PCB (not shown) to an electrically conductive pad (not shown). The pin 400 has a rod 401 that is made out of an electrically conductive material, such as, but not limited to aluminum, steel, zinc, and/or any alloy thereof. In a preferred embodiment, there is gold plating on the end of the rod 401. The rod 401 mates with an electrically conductive pad on another module (not shown). The rod 401 can move vertically in the cavity 450 of barb casing 410. An electrically conductive solder tail 440 is at the bottom of the barb casing 410 and connects the PCB (not shown) to the pin 400. An electrically conductive spring 420 is attached at one end to the top facet of the solder tail 440 and at the other end to the bottom facet of the rod 401. In a preferred embodiment, the spring 420 is gold-plated to improve conductivity. The spring 420 is housed in the cavity 450 of the barb casing 410. The bottom of the rod 401 is a casing 430 that is electrically conductive. The entire pin system 400 is electrically conductive and in constant contact. The barb 411 on the exterior perimeter of the barb casing 410 is a sealant preventing debris and/or liquid from entering the PCB and/or interrupting the connection between the pin 400 and the PCB (not shown).

FIGS. 37A and 37B shows a flowchart for the operation of two modules, when a first module is a handle and a second module is an optical head with at least two optical lenses for capturing images. This 360° optical device is operational when the handle module and the optical head module are electrically connected. To activate and power on the 360° optical device, a user can depress or otherwise activate the start-up button activator 101. The start-up button activator 101 turns on the 360° optical device and proceeds to battery check 201. If the battery has low power, a speaker or other audio or visual signal will notify the user 301 and continue to boot the 360° optical device. If the battery 201 has ample power, a firmware check update 202 of the system is engaged.

After the firmware check, a settings check 203 is engaged. If the firmware and settings check 202, 203 indicates the firmware or settings requires updating, a speaker, signal, or other audio prompt 302 alerts the user, followed by firmware update 401 to the 360° optical device firmware. If the firmware does not require updating, and it is the first time booting the 360° optical device, speaker 303 will prompt first boot instructions and setup. After firmware update 401, the device powers off 999. If there is no firmware update 202, the device then checks settings 203 and determines whether to turn on Bluetooth 501, and/or connect wirelessly 502, (using one of protocol 802.11a/b/g/n/ac on 2.4 and/or 2.5 GHz) and/or turn on wireless hotspot 503.

If the Bluetooth 501 is activated, the device waits for a connection 205. If no device has connected or the device has not received a Bluetooth command for an extended length of time and the device has not been recording/streaming or taking still images or plugged into USB 500 for an extended length, the device will power off 999. If the device detects a Bluetooth connection during 205, it will then pair and wait for command 206.

If the 360° optical device tries to connect to Wi-Fi 502, the device will check if the Wi-Fi connection is successful 207 and a connection is created. A speaker or other signal will send an error message 306 if the device is unable to find or connect to a Wi-Fi network and/or establish an internal connection, otherwise the 360° optical device will stream video to the cloud storage, LAN, and/or save locally 406.

When the Wi-Fi hotspot 503 is activated, the 360° optical device will check if any clients have connected 208. If a client has connected, the device will wait for a command (having the ability to stream video) and allow remote control 407. If no device has connected and the device has not been recording/streaming or taking still images or plugged into USB 500 for a predetermined period of time, the device will power off 999.

When the 360° optical device is plugged into a USB 500, the device will begin pulling power from the connected USB device and charge the battery 000. The device will check if the USB 500 connection is from a computer or other certified accessory 209. If the USB connection is from a computer, the device speaker or other notification system will notify the user of USB connection 307 and activate mass storage mode 409. When the device detects USB disconnection, speaker or other notification system 308 will notify user and if the device is not recording/streaming/transferring data or taking still images, the device will power off 999.

Alternatively, if it's not the first time booting the 360° optical device, and the device is powered on or plugged into USB 500, the user can activate start-up button activator 100. If the button 100 is depressed once, the storage on the device is checked 204a. If there is storage space, a device makes a sound and/or other signal 304 to indicate there is storage space and video will start recording 402.

Activating the button 101 twice more will take a single photo 403 during the video and/or audio recording process. Activating the button 101 once while recording will stop the device from recording audio and/or video 210. When the device stops recording, it will wait for a command for a predetermined time before powering off. If the button 100 is depressed twice while the 360° optical device is powered on or plugged into USB 500, the storage on the device is checked 204b. If there is storage space, device makes a sound or other signalization 305 to indicate there is space and a photographic image 404 will be taken. If the button 101 is depressed a predetermined number times or held for a specific duration, the device will reset to factory settings 405. If there is no storage capacity or a storage error, speaker or signalization 309 will notify the user that the 360° optical device does not have any storage capacity.

When the start-up button activator 101 is depressed during 402 or after device has completed action 404, device will wait an extended length 210. If no actions are completed during this time and there isn't a device connected to either Bluetooth 501 or Wi-Fi, the device will power off 999.

At any time, with the exception of the device plugged into USB 500, if the 360° optical device is powered on and the start-up button activator 101 is depressed for extended duration the Device will stop any video/image recording/streaming and power off 999.

FIG. 38 is a block diagram of a 360° camera when the optical head is electrically connected to a handle. In a preferred embodiment the video and image processor 100 is electrically connected to a PCB on the optical head (not shown). In another preferred embodiment, the video and image processor 100 is connected to a PCB on the handle (not shown). At least one microphone 200 is connected to the video and image processor 100 for alerting a user and/or recording audio data. At least one Micro SD card 300 is connected to the video and image processor 100 for storing data captured by a sensor. At least one LED 400 is connected to the video and image processor 100 for illumination, status notification, and/or aesthetics. At least one lens and sensor 500 can be connected to the video and image processor 100 for capturing and processing image data. When there are at least two lenses that can capture images that overlap, the stitching algorithm can stitch together the two images at the point(s) of overlap for a mosaic image.

The NAND/EEPROM 600 is connected to the video and image processor 100 for firmware storage. There is at least one button 10 that when activated can alert the at least one custom connector 700 and/or custom connector 730 which alerts a battery management system 720 and battery 710. In a preferred embodiment the battery is a lithium ion or lithium ion polymer battery.

At least one LED Controller 800 is connected to the video and image processor 100 for illumination, status notification, and/or aesthetics. A LED Ring 810 is connected to the LED Controller 800.

The video and image processor 100 can communicate and/or transmit data using an IEEE 802.11 wireless protocol 900 such as, but not limited to: 802/11/a/b/g/n/ac/ad. In addition, the video and image processor 100 can transmit data using Bluetooth and/or BLE 910. The data is cached at data cache 920 which can also communicate with video and image processor 100.

Although only a few embodiments of the present invention have been described herein, it should be understand that the present invention might be embodied in many other specific forms without departing from the spirit or scope of the invention. Therefore, the present examples and embodiments are to be considered as illustrative and not restrictive, and the invention may be modified.

What is claimed:

1. A device comprised of at least two detachable and interchangeable modules, wherein a first module is a three-dimensional structure, a second module is a three-dimensional structure, the first module has a first facet capable of connecting to a first or a second facet of the second module, the first module having at least one sensor capable of sensing data, the second module having a power source which, when the first and second modules are mechanically connected at the first module's first facet and the second module's first or second facet, creates a seal which encloses an electrical connection capable of passing power and data and creating a ground connection between the first and second module.

2. The device according to claim 1, wherein the first module has a data storage unit capable of storing and retrieving data sensed by the sensor.

3. The device according to claim 1, wherein the second module has a data storage unit capable of storing and retrieving data sensed by the sensor.

4. The device according to claim 1, wherein the power source is a battery.

5. The device according to claim 4, wherein the battery is removable and either a lithium ion or lithium polymer battery.

6. The device according to claim 1, wherein the first module has at least two optical lenses and at least one sensor capable of sensing image data, wherein the at least two optical lenses have a plurality of points where the image sensed by the least two optical lenses overlap, and at least one video and image processor unit.

7. The device according to claim 1, wherein the sensor is at least one of: a humidity sensor, a temperature sensor, an infrared sensor, an acoustic sensor, a sound sensor, a vibration sensor, an automotive sensor, a transport sensor, a chemical sensor, an electric current sensor, an electric potential sensor, a magnetic sensor, a radio sensor, a flow sensor, a fluid velocity sensor, a radiation sensor, a navigational sensor, a position sensor, an angle sensor, a displacement sensor, a distance sensor, a speed sensor, an acceleration sensor, an optical sensor, a light sensor, an imaging sensor, a photon sensor, a pressure sensor, a force sensor, a density sensor, a level sensor, a thermal sensor, a heat sensor, a proximity sensor, a presence sensor, a sonar sensor, a micro-electrical mechanical system sensor, a radar sensor, an ultrasonic sensor, or an air pollution sensor, and an air quality sensor.

8. The device according to claim 1, wherein the seal is an independent and removable O-ring.

9. The device according to claim 1, wherein the seal is a molded gasket affixed to a first module.

10. The device according to claim 1, wherein the seal is an independent O-ring, molded gasket, and hydrophobic coatings.

11. The device according to claim 1, wherein the electrical connection is a plurality of spring loaded and retractable pins on the second module and target pads on the first module.

12. The device according to claim 10, wherein the electrical connection is a plurality of spring-loaded and retractable pins on the first module and target pads on the second module.

13. The device according to claim 1, wherein the electrical connection is a plurality of plugs and sockets.

14. The device according to claim 1, wherein the passing of power and data adheres to the USB 2.0 High speed specifications.

15. The device according to claim 1, wherein the mechanical connection between the first and second module is a bisymmetric bayonet joint.

16. The device according to claim 1, wherein the mechanical connection between the first and second module is a sleeve connected to the second module that can rotate to mate to the first module.

17. The device according to claim 1, wherein the mechanical connection between the first and second module is an over-center clip, wherein the second module has at least a first clip on a first side and a second clip on a second side, that can securely clip into a first and second hook on the first facet of the first module.

18. The device according to claim 1, wherein the second module has at least one activator that when activated can transmit data stored the second module's data storage unit to an external storage unit not physically wired to the device.

19. The device according to claim 1, wherein the second module has a removable base cap.

20. The device according to claim 1, wherein the first and second module are prevented from decoupling, the first module having a plurality of keys and second module having a plurality of key orifices, wherein the keys of the first module mate to the key orifices of the second module.
